(19) United States
(12) Patent Application Publication
(10) Pub. No.: US 2017/0095692 A1
(43) Pub. Date: Apr. 6, 2017

(54) SYSTEM AND METHOD FOR RUN TRACKING WITH A WEARABLE ACTIVITY MONITOR

(71) Applicant: Lumo BodyTech, Inc, Mountain View, CA (US)

(72) Inventors: Andrew Robert Chang, Sunnyvale, CA (US); Chung-Che Charles Wang, Palo Alto, CA (US); Andreas Martin Hauenstein, San Mateo, CA (US); Dennis William Bohm, Mountain View, CA (US)

(21) Appl. No.: 15/283,016

(22) Filed: Sep. 30, 2016

Related U.S. Application Data
(60) Provisional application No. 62/236,438, filed on Oct. 2, 2015.

(51) Int. Cl. A63B 24/00; G09B 5/02

(52) U.S. Cl. CPC A63B 24/0062; G09B 5/02; A63B 24/0003; A63B 24/0021; A63B 2024/0025

(57) ABSTRACT

A system and method for tracking running activity that includes an activity monitor device with an inertial measurement system, a communication module, a processor configured to generate a set of biomechanical signals from kinematic data collected from the inertial measurement system, a housing that internally contains the inertial measurement system, the communication module, and the processor, and an electrical interface exposed on the external side of the housing; and a user application operable on a second computing device distinct from the activity monitor device; wherein communication and generation of biomechanical signals are operable in many modes.

### CROSS-REFERENCE TO RELATED APPLICATIONS

This application claims the benefit of U.S. Provisional Application No. 62/236,438, filed on 2 Oct. 2015, which is incorporated in its entirety by this reference.

### TECHNICAL FIELD

This invention relates generally to the field of activity tracking and more specifically to a new and useful system and method for tracking running with a wearable activity monitor.

### BACKGROUND

In recent years, numerous fitness monitoring apps and devices have been introduced to the public. Many of these devices function as basic pedometers. Other devices characterize activity in a generic manner to quantify activity in an abstract manner. Such tools, however, fail to provide insight into particular performance metrics for a participant. Additionally such devices commonly can be uncomfortable to wear or use during an activity. Thus, there is a need in the activity-tracking field to create a new and useful system and method for tracking running with a wearable activity monitor. This invention provides such a new and useful system and method.

### BRIEF DESCRIPTION OF THE FIGURES

FIG. 1 is a schematic representation of a system of a preferred embodiment;

FIG. 2 is a schematic representation of a system for use of an activity monitor and an application of a preferred embodiment;

FIG. 3 is a schematic representation of activity monitor device;

FIG. 4 is a schematic representation of a non-rigid coupling of the activity monitor device;

FIG. 5 is a schematic representation of a variation of an external form of an activity monitor device;

FIG. 6 is a schematic representation of a variation of the garment electrical interface;

FIG. 7 is a schematic representation of a clip attachment;

FIGS. 8A-8D are screenshot representations of variations of the user application in a report mode;

FIG. 9 is a flowchart representation of a method for use of an activity monitor and application of a preferred embodiment;

FIG. 10 is a flowchart representation of a variation of a method for use of an activity monitor and application of a preferred embodiment;

FIG. 11 is a flowchart representation of a method for a variation of dynamic communication;

FIG. 12 is a schematic representation of changing signal strength;

FIG. 13 is a schematic representation of augmenting biomechanical signal processing resolution;

FIG. 14 is a flowchart representation of a method of a preferred embodiment;

FIG. 15 is a schematic representation of a sequence of delivering coaching advice for similar portions of a run;

FIG. 16 is a schematic representation of an exemplary biomechanical signal prioritization;

FIG. 17 is a schematic representation of an exemplary biomechanical signal prioritization with performance considerations;

FIG. 18 is a schematic representation of an exemplary biomechanical signal prioritization that uses user input;

FIG. 19 is a schematic representation of orientation calibration; and

FIG. 20 is a schematic representation of possible biased orientations of an activity monitor device.

### DESCRIPTION OF THE EMBODIMENTS

The following description of the embodiments of the invention is not intended to limit the invention to these embodiments but rather to enable a person skilled in the art to make and use this invention.

### 1. Overview

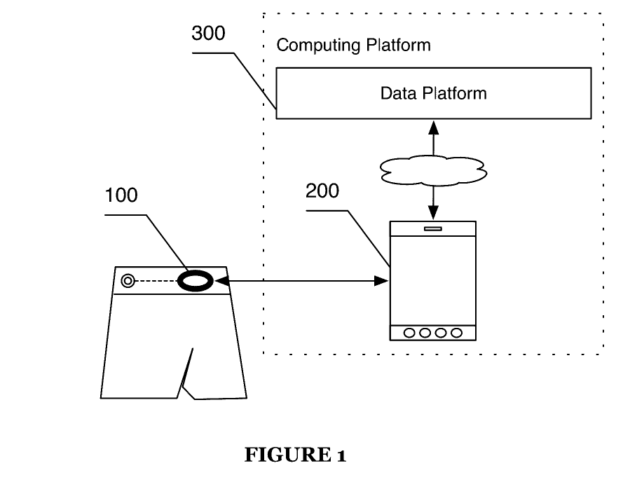

As shown in FIG. 1, a system and method of a preferred embodiment can include a wearable activity monitor device and a computing platform. The computing platform can include a user application operable on a secondary device, a running biomechanical logic model, and a cloud platform. The wearable activity monitor may electrically interface with a garment, a controller, or any suitable device. The systems and methods of the preferred embodiments function to provide an improved running experience through a wearable activity monitor device.

As another potential benefit, the system and method can enable improved detection and analysis of a running activity. The system and method can detect and analyze biomechanical properties of a participant running. Biomechanical signals generated based on sensed movement are preferably generated on the activity monitor device. A biomechanical signal preferably parameterizes a biomechanical-based property of some action by a participant (e.g., a user of the activity monitor device). More particularly, a biomechanical signal quantifies at least one aspect of motion that occurs once or repeatedly during a task such as biomechanical properties relating to a step made by the participant. Through building knowledge around the biomechanical properties of running, the system and method preferably provide unique ways of generating user feedback and delivering user feedback during an activity. The system and method can be used to deliver specific instructions on improving performance.

As another potential benefit, the system and method can address the wearability of an activity monitor such as the integration of electronic components in a garment and how an enhanced garment interfaces with a sensing system promote more comfortable wearable technology. Similarly, the system and method can be applied to augmenting the operation of the activity monitor device for enhanced performance. The detection of biomechanical properties, power and communication capabilities of the activity monitor device, and/or historical analysis across one or more participants can be applied to alter how data is collected, stored, and/or communicated. Such advancements can enable a more compact and/or affordable design and/or improved quality of data.

The system and method can be used in monitoring and augmenting the running experience of a runner. In some implementations, the system and method involves the activity monitor device controlled by a user from a user application. In other implementations, the system and method can interface with an enhanced garment or other user input device and the user may alternatively or additionally control the activity monitor device using provided inputs. As an exemplary use-case, the runner will preferably initially select a pair of enhanced running shorts or pants (i.e., an enhanced garment) to wear. Typically, the enhanced garment may be provided with one or more sensors within the garment that can sense and determine parameters related to the movement of the user whilst running for example. The parameters as detected by the sensors can be provided to feedback elements, which are used to provide feedback to the wearer about the run, and his or her motion during the run. In some cases the feedback elements may also be integrated into the garment.

Then the runner will connect a wearable activity monitor to the enhanced garment. A conductive connection between electrical components of the enhanced garment and those of the activity monitor device is preferably made by inserting the activity monitor device in a waistband pocket or sleeve. The corresponding design of the electrical connectors in the enhanced garment and the activity monitor can promote a consistent electrical connection when inserted in the pocket. Algorithmic analysis of signals received through the electrical connection can be used to account for disturbances in the electrical connection. The activity monitor will additionally have communication access to a user application, and the user application will additionally be capable of communicating with a remote, network-accessible cloud system. The user application and/or network accessible cloud system may be used for applying historical analysis of the participant and optionally multiple participants utilizing the cloud system. The runner can then use an interface of the enhanced garment or that of a connected user application to track performance and receive user feedback. Preferably, the positioning of the activity monitor in the waistband can enable a comprehensive set of biomechanical signals to be collected that reflect the biomechanical properties of how the runner moves when running. A running biomechanical logic model can be operative within the application to guide how user feedback is provided. The running biomechanical logic model can account for various aspects that are interpreted from detected biomechanical signals.

### 2. System and Method for Use of an Activity Monitor and Application

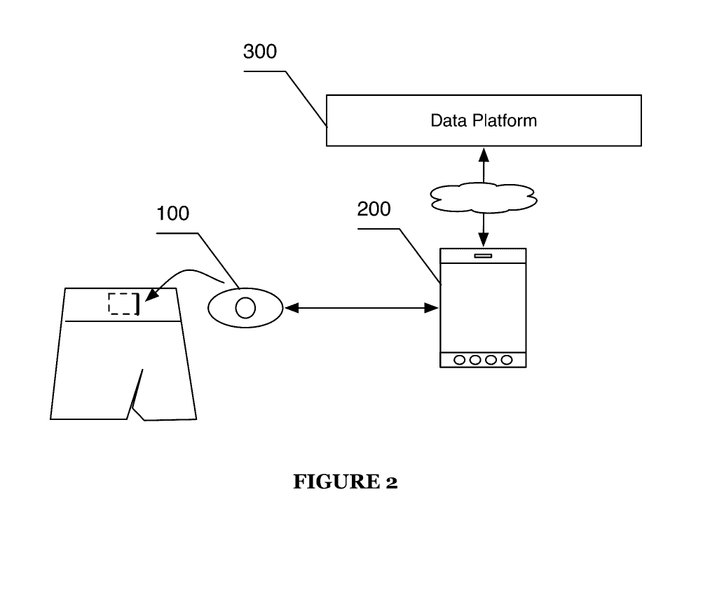

As shown in FIG. 2, a first system can include a wearable activity monitor device 100, a user application 200, and optionally a cloud-hosted data platform 300. The system preferably functions to provide the elements for activity tracking and user feedback. More specifically, the system can be used to provide progress tracking, instructional guidance, and injury prevention warnings through use of a wearable device. The system and method is preferably applied to the field of running, jogging, and/or walking. In one implementation, the system can be combined with an enhanced garment and a biomechanical running logic model to supplement the capabilities of the system. In another implementation, the system can be used without integration with an enhanced garment—an activity monitor device 100 can be used independently or in combination with a user application 200 and/or cloud hosted data platform 300. The system can also be specifically targeted at marathon running, sprinting, rehabilitation, movement disorders, and other more specific locomotion use cases. The system and method may alternatively be applied to other activities such as cycling, rowing, swimming, golfing, weightlifting, aerobics, fitness training, medical applications (e.g., remote monitoring, fall detection, rehabilitation, and the like), ergonomics monitoring (e.g., monitoring construction workers, industrial warehouse workers), or any suitable field of use. Herein, the system and method are described primarily for a running or jogging use case, but such an embodiment may alternatively be customized for any suitable use case. The activity monitor device 100 may provide a mechanism to track activity and connect to a garment enhanced with electrical components such as sensors and feedback elements. The user application 200 can provide processing capabilities, enhanced user interface elements, actionable feedback to improve biomechanical movement patterns, and/or connection to cloud services like the cloud platform.

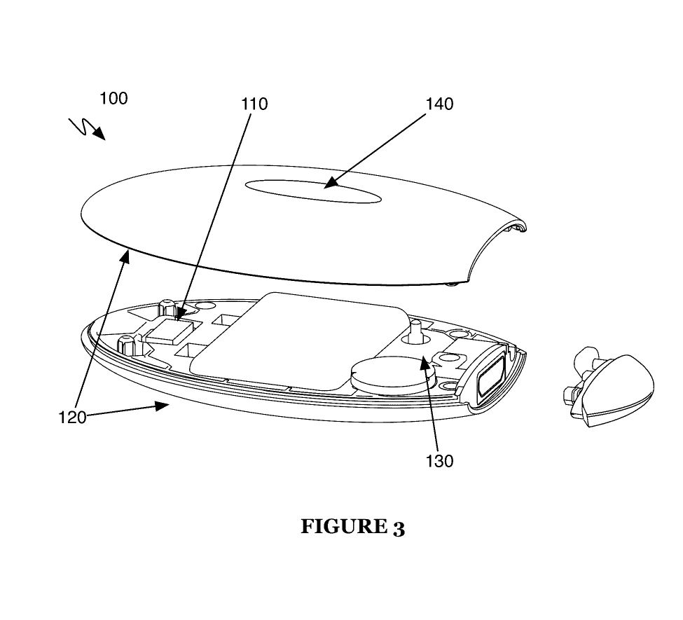

As shown in FIG. 3, the activity monitor device 100 preferably includes an inertial measurement system 110, a housing 120, a communication module 130, and a garment electrical interface 140. The activity monitor device 100 can additionally include any suitable components to support computational operation such as a processor, RAM, flash memory, user input elements (e.g., buttons, switches, capacitive sensors, touch screens, and the like), user output elements (e.g., status indicator lights, graphical display, speaker, audio jack, vibrational motor, and the like), communication components (e.g., Bluetooth LE, Zigbee, NFC, Wi-Fi, and the like), and/or other suitable components.

Preferably, the activity monitor device 100 is a dedicated activity monitor device 100. Alternatively, the activity monitor device 100 could be a multi-purpose device such as a smart watch, smart phone, or any suitable personal computing device. The activity monitor device 100 could be configured to be a stand-alone device without requiring or depending on other computing devices. The activity monitor device 100 may alternatively depend on or provide enhanced features when used in combination with a remote computing device such as the user application 200 and/or the data platform 300.

The inertial measurement system 110 of the activity monitor functions to measure multiple kinematic properties of an activity. The inertial measurement system 110 preferably includes at least one inertial measurement unit (IMU). An IMU can include at least one accelerometer, gyroscope, or other suitable inertial sensor. The inertial measurement unit preferably includes a set of sensors aligned for detection of kinematic properties along three perpendicular axes. In one variation, the inertial measurement unit is a 9-axis motion-tracking device that includes a 3-axis gyroscope, a 3-axis accelerometer, and a 3-axis magnetometer. The inertial measurement system 110 can additionally include an integrated processor that provides sensor fusion in hardware, which effectively provides a separation of accelerations caused by gravity from accelerations caused by speed changes on the sensor. The on-device sensor fusion may provide other suitable sensor conveniences or sensor data processing. Alternatively, multiple distinct sensors can be combined to provide a set of kinematic measurements. The activity monitor device 100 can additionally include other sensors such as an altimeter, GPS, magnetometer, or any suitable sensor.

The activity monitor device 100 preferably utilizes the inertial measurement system no in the detection of a set of biomechanical signals.

A biomechanical signal preferably parameterizes a biomechanical-based property of some action by a user. More particularly, a biomechanical signal quantifies at least one aspect of motion that occurs once or repeatedly during the activity. For example, in the case of walking or running, how a participant takes each step can be broken into several biomechanical signals. In a preferred implementation, the system and method preferably operate with a set of biomechanical signals that can include cadence, ground contact time, braking, pelvic rotation, pelvic tilt, pelvic drop, vertical oscillation of the pelvis, forward oscillation, forward velocity properties of the pelvis, step duration, stride length, step impact, foot pronation, foot contact angle, foot impact, body loading ratio, foot lift, motion paths, and other running stride-based signals.

Cadence can be characterized as the step rate of the participant.

Ground contact time is a measure of how long a foot is in contact with the ground during a step. The ground contact time can be a time duration, a percent or ratio of ground contact compared to the step duration, a comparison of right and left ground contact time or any suitable characterization.

Braking or the intra-step in forward velocity is the change is the deceleration in the direction of motion that occurs on ground contact. In one variation, Braking is characterized as the difference between the minimum velocity and maximum velocity within a step, or the difference between the minimum velocity and the average velocity within a step. Braking can alternatively be characterized as the difference between the minimal velocity point and the average difference between the maximum and minimum velocity. A step impact signal may be a characterization of the timing and/or properties relating to the dynamics of a foot contacting the ground.

Pelvic dynamics can be represented in several different biomechanical signals including pelvic rotation, pelvic tilt, and pelvic drop. Pelvic rotation (i.e., yaw) can characterize the rotation in the transverse plane (i.e., rotation about a vertical axis). Pelvic tilt (i.e., pitch) can be characterized as rotation in a the sagittal plane (i.e., rotation about a lateral axis). Pelvic drop (i.e., roll) can be characterized as rotation in the coronal plane (i.e., rotation about the forward-backward axis).

Vertical oscillation of the pelvis is characterization of the up and down bounce during a step (e.g., the bounce of a step).

Forward velocity properties of the pelvis or the forward oscillation can be one or more signals characterizing the oscillation of distance over a step or stride, velocity, maximum velocity, minimum velocity, average velocity, or any suitable property of forward kinematic properties of the pelvis.

Step duration could be the amount of time to take one step. Stride duration could similarly be used, wherein a stride includes two consecutive steps.

Foot pronation could be a characterization of the angle of a foot during a stride or at some point of a stride. Similarly foot contact angle can be the amount of rotation in the foot on ground contact. Foot impact is the upward deceleration that is experienced occurring during ground contact. The body-loading ratio can be used in classifying heel strikers, midfoot, and forefoot strikers. The foot lift can be the vertical displacement of each foot. The motion path can be a position over time map for at least one point of the runner's body. The position is preferably measured relative to the athlete. The position can be measured in one, two, or three dimensions. As a feature, the motion path can be characterized by different parameters such as consistency, range of motion in various directions, and other suitable properties. In another variation, a motion path can be compared based on its shape.

Additionally, the biomechanical signals can include left/right detection, which may be applied for further categorizing or segmenting of biomechanical signals according to the current stride side. The pelvis is used as a preferred reference point. The pelvis can have a strong correlation to lower body movements and can be more isolated from upper body movements such as turning of the head and swinging of the arms. The sensing point of the activity monitor device 100 is preferably centrally positioned near the median plane in the trunk portion of the body. Additional sensing points or alternative sensing points may be used. In one variation, the position and/or number of sensing points can be adjusted depending on the activity. The number of sensing points may be increased by increasing the number of inertial measurement systems 110 and/or the number of activity monitor devices 100. In one variation, multiple activity monitor devices can be used to enhance the detection of the set of biomechanical signals. In another variation, a first activity monitor device may be used to detect a first set of biomechanical signals, and a second activity monitor device may be used to detect a second set of biomechanical signals; and the first and second set of biomechanical signals are distinct sets. Multiple activity monitoring devices 100 preferably communicate wirelessly and cooperate in generating a set of biomechanical signals. Alternatively, a wired or wireless inertial measurement system may communicate kinematic data to a main activity monitor device for processing.

The housing 120 primarily functions as a structural container for the components. The housing 120 can internally contain the inertial measurement system 110, the communication module 130, and other computing elements. The housing 120 can be made of any suitable material such as metal, plastic, or composite. The housing 120 may additionally include or be made from organic materials such as wood and/or leather. The housing 120 can be sealed to allow the activity monitor to be washed, used when swimming, and/or exposed to moisture (e.g., sweat). Accordingly, the housing 120 can include water seals at any water entry points.

The housing 120 can be a single piece but is preferably a set of pieces that are fastened together. The housing 120 can have a set of ports or electrical interfaces. A first electrical interface can be the garment electrical interface 140 that enables the activity monitor device 100 to interact with an enhanced garment that may be provided with sensors and/or feedback elements. Other possible electrical interfaces may include a charging port such as a micro USB connector, which may be used in charging and/or data transfer. The activity monitor device 100 preferably includes an internal, rechargeable battery used for powering the components. In one variation, the housing 120 includes a removable sealing cover mechanically coupled to the electrical connector to provide water sealing. The detachable sealing cover can be fixed into place using a latch, magnets, friction, or another suitable mechanism. A seal along the electrical connector preferably establishes a watertight seal. In yet another variation, the device may be charged through the garment electrical interface 140. The activity monitor may alternatively charge through wireless charging, operate on batteries, or obtain power through any suitable mechanism. In the wireless charging variation, the activity monitor device 100 can be wirelessly charged by wirelessly coupling with a charging station.

The housing 120 can have an external form and an internal form. The internal form (i.e., the internal portion of the housing structure) can define any suitable cavity or molding to hold the various components. The external form (i.e., the outside portion of the housing structure) may function to promote mechanical coupling with one or more types of interfaces. One preferred interface to which the activity monitor devices will mechanically (and electrically) couple is that of an electrical connector of an enhanced garment through the garment electrical interface 140.

In one implementation, the external form can promote non-rigid mechanical coupling, which functions to make the activity monitor and corresponding enhanced garments more “wearable”. Preferably, rigid mechanical components do not need to be built into an enhanced garment to enable the activity monitor device 100 to “clip in”. Non-rigid mechanical coupling may enable a user to simply slip the activity monitor device 100 into a pocket, and the defined cavity of the pocket and elastic elements in the garment force a steady state position of the activity monitor device 100 when in the pocket. This avoids unconformable structures in a garment but additionally enables an enhanced garment to be made through more traditional garment manufacturing processes such as providing a small pocket.

A non-rigid mechanical coupling will generally result in variability in the orientation of the activity monitor device 100 when inserted into a pocket of an enhanced garment. The activity monitor device 100 preferably includes processes to computationally calibrate and compensate for orientation variations between different activity sessions and/or during activity. More specifically, the activity monitor device can include configuration to account for vertical or horizontal alignment and to detect a forward-backward axis. Additionally or alternatively, a user application 200 may provide manual controls to facilitate calibrating orientation of the activity monitor device 100. Configured orientation compensation can additionally be supplemented through an external form that promotes a biased orientation at least along one axis.

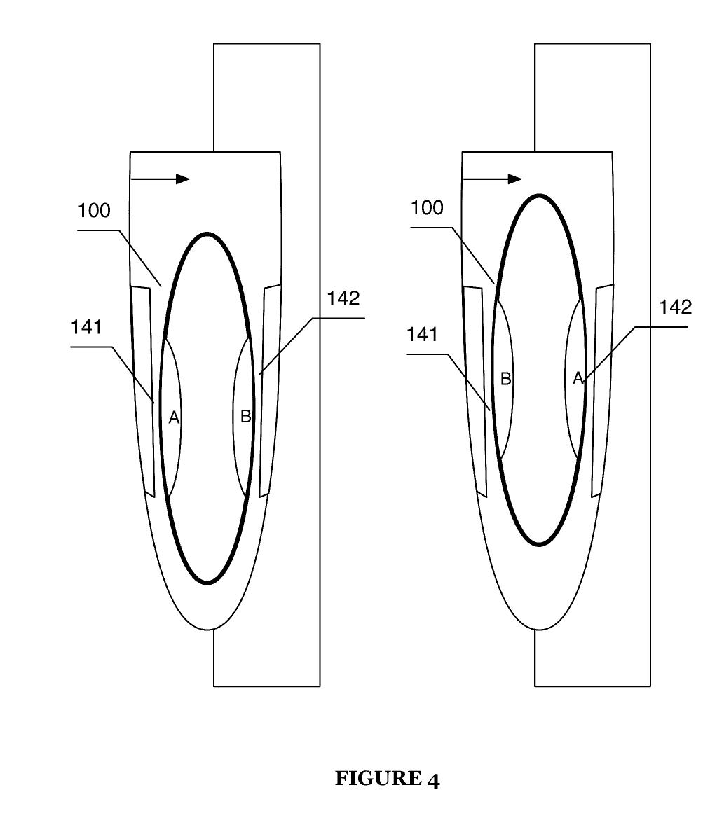

In a non-rigid mechanical coupling variation, the external form is preferably configured to promote orienting in one of two forward or backwards positions when coupling the garment interface 140. The two positions can include a position with a first surface of the activity monitor device in a forward-dominant orientation and a position with a second surface of the activity monitor device in a forward-dominant orientation. Here forward-dominant orientation describes an orientation with one of the two surfaces being more biased in the forward direction of the user. The two positions preferably physically orient the yaw or rotation about the transverse plane of the activity monitor device 100. The orientation of the activity monitor device 100 may be oriented in a range of positions with respect to roll (rotation about the coronal plane) and pitch (rotation about the sagittal plane) of the device. The activity monitor device 100 may be made to bias the pitch and roll orientation in one or more possible positions. The external form is preferably a substantially flat form and includes two opposing external surfaces. The external form can be coin-shaped, pebble shaped, card shaped, or any suitable form with two faces. The external surfaces preferably have a slight dome shape. The dome shape can promote focusing compression forces at the top of the dome form. Contact pads are preferably positioned at the top of the domes such that the shape can promote enhanced conductive contact. A contact pad is preferably a plate or region of conductive material on which another conductive element can contact to establish a conductive coupling. The contact pad is preferably a solid metal pad but could alternatively be made flexible or of any suitable conductive material. The two opposing surfaces preferably promotes two steady-state rest orientations with an applied opposing force, wherein the opposing force is perpendicular to a defined plane of either of the two surfaces in steady state. An elastic waistband or any suitable tightened garment may provide such an opposing force. In other words, the monitor will likely sit flat in the pocket with either one or the other surface facing out when the walls of a pocket apply a compression force as shown in FIG. 4. Algorithmic orientation calibration of the kinematic data from the inertial measurement system 110 is preferably still performed for the forward-backwards axis to account for small angle differences, which may arise from a waistband being positioned oddly or the senor having a slight tilt. The two opposing external surfaces can be curved but may alternatively be flat or have any suitable form.

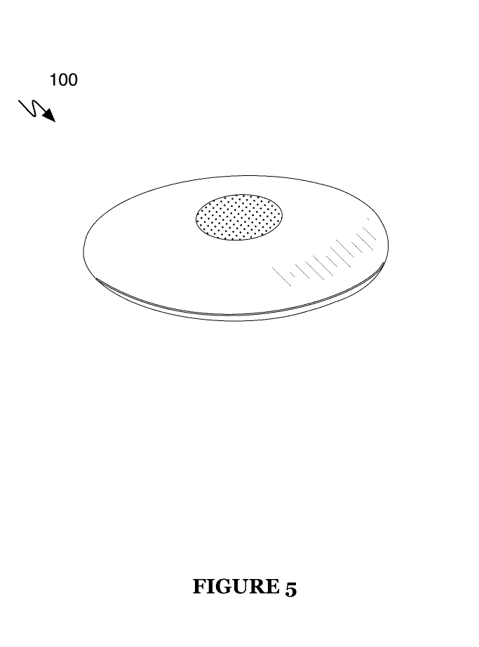

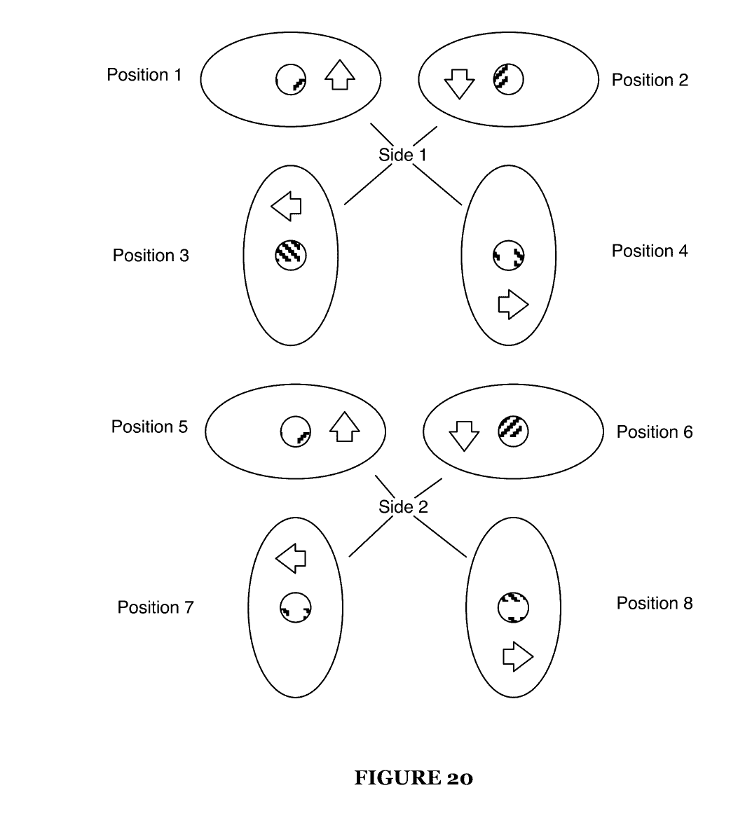

In other variations, the form of the activity monitor device 100 may be non-circular and can be oblong as shown in FIG. 5. Meanwhile a holder or receptacle for the activity monitor device 100 can have proportional dimensions to further restrict the orientation of the activity monitor device 100 when inserted in a pocket or into a clip attachment. Accordingly, the roll and/or the pitch can be similarly biased to particular orientations in a similar manner to yaw. In one variation, there are preferably four biased positions for an activity monitor device 100 when affixed to a receptacle such as a holder. A long pocket that is along the waistband may promote a sideways orientation as shown in positions 1, 2, 5, and 6 in FIG. 20. An attachment clip may promote a vertical orientation as shown in positions 3, 4, 7, and 8 in FIG. 20. When a garment or an attachment clip can be used, then there may eight biased orientations of the activity monitor device.

The communication module 140 functions to communicated with an outside computing resource. The outside computing resource is preferably the user application 200 operable on a personal computing device or any suitable computing device. The computing device is preferably distinct from the activity monitor device 100. The communication module 140 is preferably a near field communication module such as a Bluetooth LE module but any suitable medium of communication can be used. The communication module 140 can be a shortwave radio communication module such as a Bluetooth module, wherein the user application 200 and the activity monitor device 100 communicate over Bluetooth Low Energy. Alternatively, the communication module 140 may manage an internet, telephony, or other suitable data communication connection to a remote server. The remote server can be part of a cloud-hosted data platform 300.

The activity monitor device 100 preferably communicates data relating to the kinematic activity of a participant. Preferably, the kinematic activity data from an IMU is converted to biomechanical signal data and transferred as biomechanical signals to the user application 200. The collected biomechanical signals are preferably a more compressed representation of the kinematic data as a processed analysis of a participant's movement. Additional data or messages may be transferred in response to interactions with the enhanced garment or on the user application 200. For example, when a user sends an activation signal from a button on the enhanced garment, the activity monitor device 100 can relay such information to the user application 200.

As one additional option, the activity monitor device 100 may include a dynamic communication mode. The dynamic communication mode can function to address communication reliability, data resolution, and/or battery life when the activity monitor device is used in combination with a personal computing device such as a smart phone. The dynamic communication mode may provide a number of benefits. As a first potential benefit, the activity monitor device can be made smaller and/or cheaper by operating more efficiently. For example, a smaller battery can be used when the activity monitor device can provide a high level of performance under normal operating conditions. As another potential benefit, a dynamic communication mode may enable the system to be applied to a wide variety of use cases. High-speed sprinters could use the device for per-step or even intra-step data for a particular race (e.g., a 100 meter sprint). Ultra marathoners could similarly use the device where the activity monitor device needs to operate in extreme conditions and for long durations (e.g., a 24 or more hours).

In a dynamic communication mode, the communication signal between a personal computing device and communication module 130 of the activity monitor device 100 may vary depending on various conditions such as running environment (e.g., more open space has fewer objects off which a signal can reflect), participant proportions (e.g., the body can block a communication signal when the personal computing device is on the opposite side from the activity monitor device), and/or other factors. The user application 200 may be configured to monitor communication signal strength of the activity monitor device 100 and to direct communication signal changes. The activity monitor device 100 preferably receives directions from the user application 200 and can augment communication properties. In a first variation, the communication signal strength can be changed. For example, if the signal is found to be weak, the broadcasted signal can be intensified by the activity monitor device. Similarly, if the signal is detected to be well within needed signal strength, the activity monitor device 100 may reduce or moderate the signal strength, which can help conserve battery life. In a second variation, the communication frequency may be changed. Other changes to communication may include communication rate or frequency.

In an additional or alternative variation, a dynamic communication mode may augment the collection, storage, and/or communication of biomechanical signals. The activity monitor device 100 preferably provides biomechanical signals as a way of monitoring the form of a participant. The type of the activity (e.g., a marathon, a short run, a spring), the duration of the activity, the performance of a participant, and/or other facts may be used to dynamically adjust the collection of biomechanical signals and/or the communication to a secondary computing device. Biomechanical signals are preferably generated according to step segments. In one high-resolution collection mode, a biomechanical signal value may be generated for each step during a run. A biomechanical signal value may alternatively be averaged within a step window—a number of consecutive steps. Averaging over a window may remove random error present in individual step biomechanical values. Averaging over a larger step window will generally produce information with a lower step resolution. A larger step window may also be more resilient to random noise in the values. The window size of a window of step segments can preferably be changed according to a variety of factors.

In one variation of a dynamic communication mode, the biomechanical signal resolution of a run may be high during the beginning of the run and then transition to a lower resolution. The transition may be a gradual transition or may be a distinct change. The transition could be after a particular time or distance limit. The transition may alternatively be made based on the biomechanical signals and target goals of a participant. For example, after the participant has been satisfying biomechanical goals for three minutes, the resolution of the biomechanical signals may be decreased to conserve battery life. The resolution of a run may similarly increase at some point. The resolution may increase if the biomechanical signals drift away from a target goal, the participant is nearing the end of an activity session (e.g., nearing the completion of a target 5 mile run), the participant is nearing a finishing point (e.g., a participant's home, starting position, or a designated finish point), or if any suitable trigger is detected. In another variation, the resolution may be reduced in response to the current location of the participant. Rough terrain may result in higher inconsistency, which may be counteracted through larger step windows.

As another additional option, the activity monitor device 100 may include a dynamic monitoring mode. The collection of biomechanical signals can be activated and deactivated according to one or more factors such as distance, biomechanical signal consistency, performance goals, route/location, and/or activity monitor power state. These factors could be set as conditions and used to start dynamic monitoring mode. A distance condition could be a condition based on the current distance or time of a run or the expected distance or time remaining in a run. A consistency condition could be characterized the amount of variance in one or more biomechanical signals and the duration of staying within that variance level. A performance goal condition could be characterized by one or more biomechanical signals being within satisfying a value condition (e.g., being above a value, below a value, or being within a range). Rout or location conditions could be conditions triggered based on the running path or the location of the user. A power condition could be a condition based on the amount of power on the activity device. The activity monitor device 100 may cycle through periods of collecting biomechanical signals over a period of time, and not collecting biomechanical signals over another period of time. The duration of biomechanical signal collection and the duration of rest periods may be predefined or dynamically controlled. Continuous biomechanical signal collection can be used when real-time instantaneous feedback is preferred. However, in some situations, periodic sampling of biomechanical signals is sufficient and can be used to extend the life of the battery. In one variation, running a long distance or for a long period of time may prompt the activity monitor device to collect biomechanical signals at periodic windows. In another variation, a participant achieving consistent biomechanical signals at or above a target level may have the activity monitor device 100 temporarily enter a rest mode. The duration of the rest mode may be based on the level of consistency of the biomechanical signals (e.g., consistent for two minutes vs consistent over multiple runs) but could alternatively be predefined or set in any suitable manner. After the period for the rest mode is over, the activity monitor device 100 can activate the collection of biomechanical signals. The biomechanical signals can be collected for some amount of time. There may be a minimum amount of time that biomechanical signal collection is performed. If the biomechanical signals are consistent with previous measurements (e.g., within a threshold of variance), then the activity monitor device 100 may again enter a rest mode. If the biomechanical signals have changed and/or have moved outside of a preferred target range, then continuous biomechanical signal collection or more frequent periods of biomechanical signal collection can be performed. Similarly, the correlation of the route or location to the benefits of continuous biomechanical signals may be used to activate or deactivate dynamic monitoring mode. In yet another variation, the activity monitor device may enter a dynamic monitoring mode when the power level goes below a particular threshold. As one variation, different sets of biomechanical signals may be collected at different intervals. In particular, biomechanical signals, such as pelvic dynamics, that utilize gyroscope data consume more power. The power intensive biomechanical signals could be collected at over periodic windows.

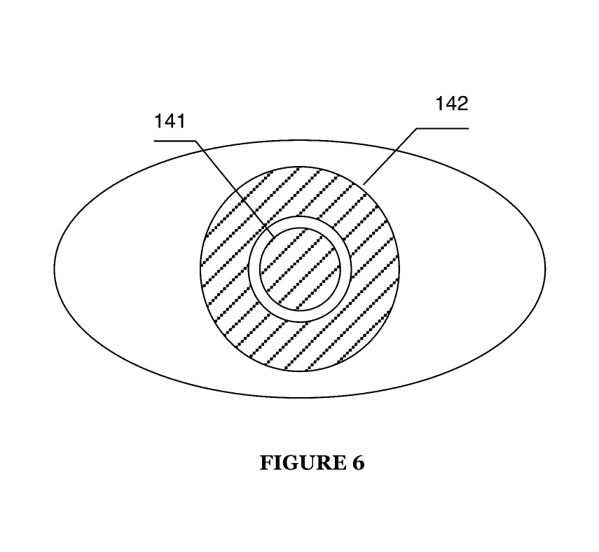

The garment electrical interface 140 functions to form an electrical connection with an enhanced garment. This can enable the system to interface with components integrated in an enhanced garment such as user input element (e.g., a button), a user output element (e.g., a haptic feedback device), and/or a sensor. The garment electrical interface 140 is preferably integrated into the external form of the housing 120. The garment electrical interface 140 preferably includes at least two contact pads: a first contact pad 141 integrated into a first surface of the external form of the housing 120 and a second contact pad 142 integrated into a second surface of the external form. A contact pad is preferably conductively connected to a lead that connects to an internal electrical component of the activity monitor device 100. The first and second surfaces are preferably the opposing surfaces such that one conductive pad is present on one side of the wearable activity device 100 and a second conductive pad is present on the opposite side of the wearable activity device 100. Preferably there are two conductive pads. There may alternatively be more than two conductive pads. For example, concentric conductive rings can be used to obtain more than one conductive pad on one side. The first and second pads 141 and 142 can be concentrically positioned on one external surface as shown in FIG. 6, with a first pad 141 surrounding the inner second pad 142. Alternative arrangements may be used. Additional pads may be used. In the concentric variation, multiple pads could be arranged in the concentric pattern and optionally additional pads could be positioned on another surface. The conductive pads can have a substantially large contact area, which may enable electrical connection to be maintained during translational movement of the activity monitor device 100 when coupled with an enhanced garment. For example, the activity monitor device 100 can shift back and forth within the pocket. The contact pads may be any suitable shape such as a circle, a stripe (as shown in FIG. 5), or any suitable shape. The contact pads can be static conductive elements, which may be flush with the external surface of the housing 120 or protrude from the external surface. The contact pads may alternatively be spring-loaded. Preferably, the contact pads 141 and 142 are metal contact pads.

During an engaged mode, the activity monitor device 100 is preferably conductively connected with a corresponding electrical interface of a garment's electrical system. The garment can be a pair of shorts, pants, belt, undergarment, shirt, jacket, or any suitable clothing item. The garment electrical system can include a user input element such as a button integrated in the garment and connected through conductive fiber. In an alternative embodiment, the activity monitor device 100 may be communicatively coupled over Bluetooth or any suitable near-field communication medium in place of a direct electrical connection. In another variation, the activity monitor device 100 can be directly integrated into a garment, and the activity monitor device 100 may not be removable from a garment. For example, the activity monitor device 100 may be sewn into an enhanced garment.

The garment electrical interface 140 can include any suitable circuitry to interface with outside components (e.g., garment buttons, garment feedback devices, etc.) connected through the garment electrical interface 140. The garment electrical interface 140 may be an input port, output port, or an input/output port of the activity monitor device 100. If the garment electrical interface 140 is an input of the activity monitor device, the garment electrical interface 140 is configured to detect incoming electrical signals from an outside component through the interface. The activity monitor device 100 is preferably configured to alter at least one process in response to input received through a signal input interface. For example, the operating mode of the activity monitor device 100 may change in response to a button press on an enhanced garment. In another example, an event notification can be communicated to the user application 200. In one variation, the electrical component of the garment can be a basic mechanical switch. In another variation, the electrical component of the garment can be a variable resistor or other suitable component to vary voltage. In yet another variation, the electrical circuit of the garment can transmit a communication through the garment electrical interface 140 such that a variety of messages may be transmitted. If the garment electrical interface 140 is an output of the activity monitor device 100, the garment electrical interface 140 can be configured to drive or activate a connected component. A connected component could include an LED, a vibration motor, a display, a speaker, a haptic feedback element (e.g., a vibrational motor), or any suitable element.

The activity monitor device 100 can be interchangeable with multiple garments. The activity monitor device 100 is preferably interchangeable with enabled garments but may additionally be interchangeable with non-enabled garments. In one variation, the activity monitor device 100 can include an attachment mechanism such as a clip, a pin, a magnet, Velcro, a fastener or other suitable mechanism. The activity monitor could additionally be held in a simple pocket of a regular, non-enhanced garment.

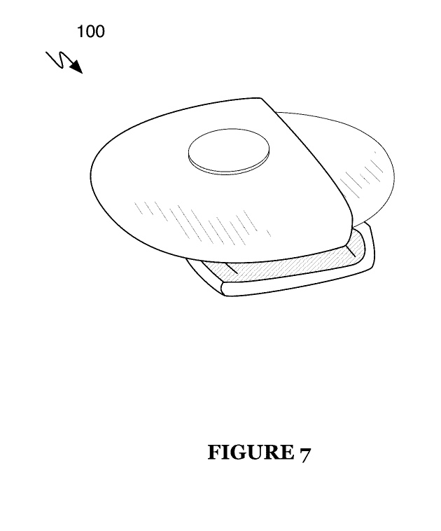

In one variation shown in FIG. 7, the system can alternatively or additionally include a clip attachment. The clip attachment may be used with the activity monitor device 100 so that the system can be used with non-enhanced garments. The clip attachment could be a separate element. The clip attachment may alternatively be directly integrated into the housing 120. The clip attachment may be a substantially static mechanical component. The clip attachment may alternatively include an electrical interface that can engage with the garment electrical interface 140 or with any suitable electrical interface. The clip attachment can include corresponding user input or output elements. If a user is not using a garment with a compatible garment electrical interface 140. The clip attachment can be used to position the activity monitor device. For example, a clip attachment may be used to position the activity monitor device 100 on the backside of a waistband of normal running shorts. The clip attachment may additionally include a compatible electrical interface and integrated electronics to approximate or replace the interactions of specialized garments. For example, a switch could be integrated to the attachment to trigger interactions. In one example, the activity monitor device 100 can be designed to work with a switch integrated into an enhanced garment. A clip attachment could include a simple switch connected contact pads that similarly conductively couple with the contact pads 141 and 142 of the activity monitor device 100.

The activity monitor device 100 may additionally include configuration to compensate for electrical signals of the garment electrical interface 140. In some instances, the garment or participant may get wet, which will lead to the activity monitor device 100 getting wet. A conductive path between the first and second contact pads 141 and 142 could occur. In other situations, the activity monitor device 100 may periodically move so as to break the conductive contact between the garment electrical interface 140 and an enhanced garment. The configured compensation preferably automatically ignores signals indicative of shorting, disconnection, or false signals.

The user application 200 functions to perform the activity tracking and user feedback processes in cooperation with the activity monitor device. The user application 200 is preferably in communication with the activity monitor device. The user application 200 can be any suitable type of user interface component. Preferably, the user application 200 is a graphical user interface operable on a user computing device. The user computing device can be a smart phone, a tablet, a desktop computer, a TV-based computing device, a wearable computing device (e.g., a watch, glasses, etc.), or any suitable computing device. The user application 200 can facilitate part or all of signal processing. Portions of the signal processing may alternatively be implemented on the activity monitor device 100 or in the data platform 300.

The user application 200 can function to enable a user to track and review information about a running or walking session. The user application 200 preferably operates in cooperation with the activity monitor device. In one implementation, the user application 200 and activity monitor device 100 can include a wait mode, a tracking mode, and a report mode.

The wait mode functions to conserve battery life of the activity monitor device. The wait mode is preferably used when a user is not using the activity monitor to track an activity such as a run. The activity monitor device 100 may be engaged with an electrical interface of an enhanced garment. During the wait mode, the activity monitor device 100 may be in a sleep mode where processing operations are kept at a minimum and power is conserved. The user application 200 may also be inactive or open in the background of an operating system. In one variation, the user application 200 may be operated without waking the activity monitor device. For example, the user may use the user application 200 in a report mode wherein the user reviews past data without activating the activity monitor device.

The wait mode may be exited in a variety of ways. In a first variation, an activation signal is received. The activation signal can be from the garment interface. For example, a user pressing a button may trigger an electrical signal detected through the garment electrical interface 140. The activation signal may alternatively be communicated to the activity monitor device 100 from the user application 200. For example, a user may start a new running session through the application, which will transition the activity monitor device 100 from a wait mode to a tracking mode. In another variation, the activity monitor device 100 can include an activity autodetection process that is periodically enabled during the wait mode. The activity monitor device 100 can process kinematic data and detect if a particular activity is underway through the activity autodetection process. The activity autodetection process may perform biomechanical signal processing on the kinematic data from the IMU 110, and if a biomechanical signal can be detected and, optionally, if the biomechanical signal satisfies a set condition (e.g., the participant is walking or running above a step rate exceeding a threshold), then the activity autodetection process can indicate the state of the activity. The autodetection process can preferably detect running and/or walking, but any alternative activity may similarly be detected. Any movement or movement-related parameter above a threshold may trigger autodetection. If running or walking is detected, the activity monitor device 100 can transition to a tracking mode.

The tracking mode functions to collect kinematic data and process the data. Kinematic data is preferably collected by the activity monitor device. The kinematic data is preferably processed into biomechanical signal data or any suitable form. Data can be periodically transferred to the user application 200. Dynamic communication mode may be utilized when communicating and generating the processed kinematic data. The kinematic data, biomechanical signal data, or any suitable data can alternatively be stored and transferred after completion of the activity. The user application 200 can process the received data and preferably provide substantially real-time feedback on the activity. Preferably, the real-time biomechanical properties of a participant's form can be reported and used by the user application 200. The user application 200 may additionally operate in a guidance mode during a tracking mode. A logic model preferably operates on the biomechanical signals to control various forms of user feedback. User feedback can include audio instructions, displayed alerts, haptic feedback, and/or any suitable form of feedback. For example, audio instructions can be played depending on the running performance.

Guidance mode can preferably provide coaching and/or recommendations during an activity. The guidance mode may similarly be used in combination with the report mode to provide coaching and/or recommendations before or after an activity. In one variation, the guidance mode utilizes an automatic coaching approach that focuses on a particular biomechanical property as described below.

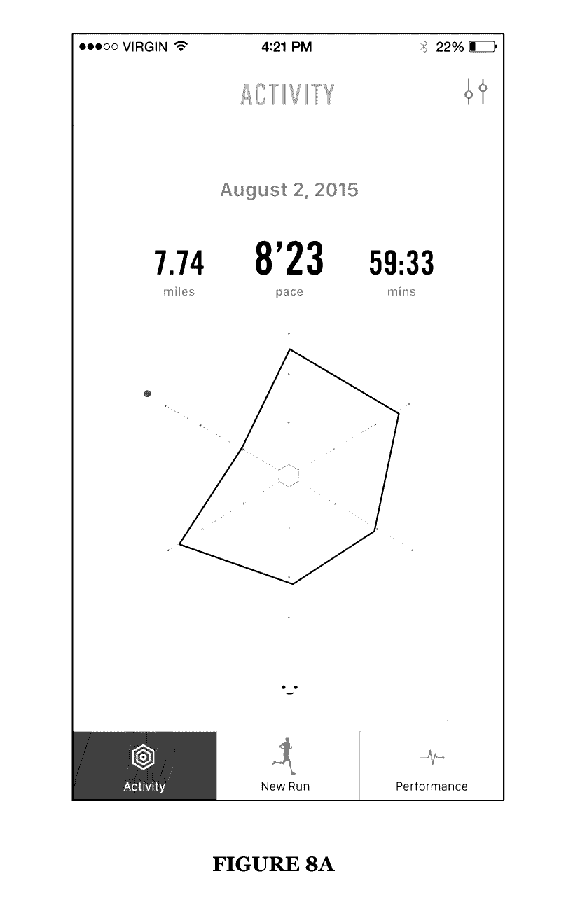

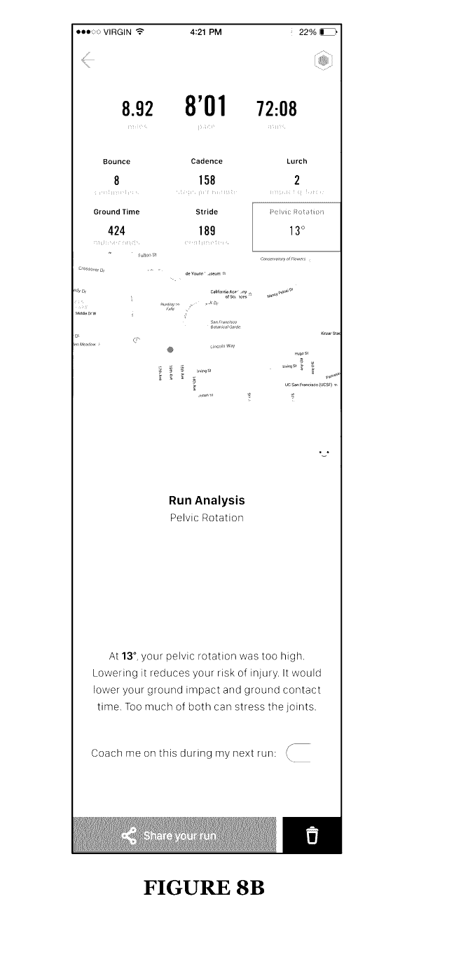

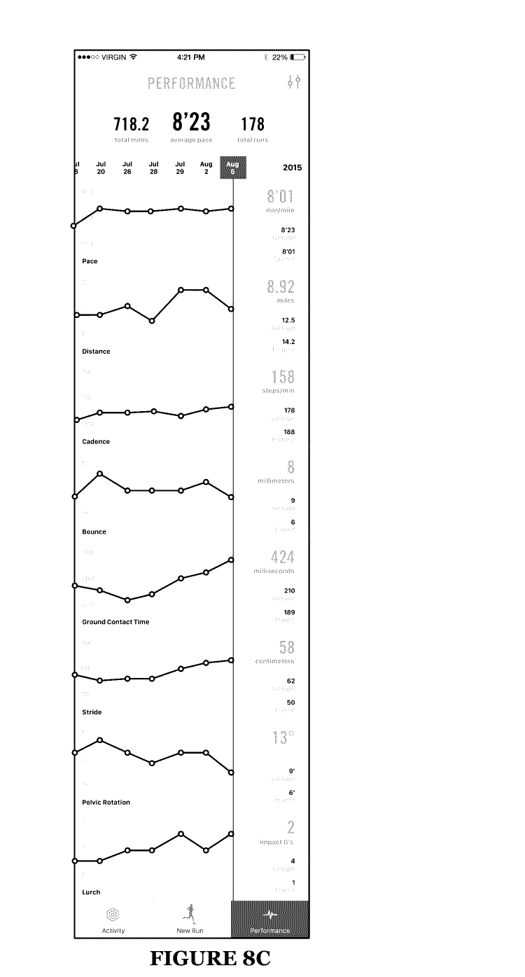

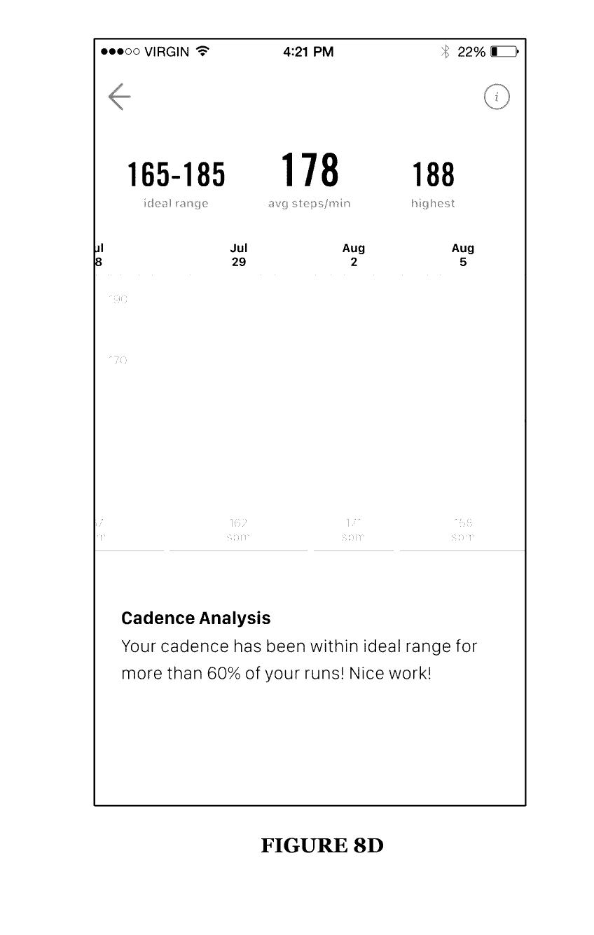

The report mode functions to enable a user to review activity data. The report mode of a user application 200 can be during an activity or after completion. Various forms of information can be presented. In one exemplary implementation, the user application 200 presents the biomechanical signals as a graphic that characterizes the biomechanical properties of a participant's performance as shown in FIG. 8A. Summarizing stats of a running session may additionally be presented as shown in FIG. 8B. The report mode can additionally present historical performance information as shown in FIG. 8C, supplemental information, and any suitable form of information. In one variation, a detailed historical report for a particular attribute of running performance can be reviewed as shown in FIG. 8D.

The system can additionally include a calibration mode, which function to enable the system to be agnostic to activity monitor positioning when engaged with in an interface of a garment. During calibration mode, the kinematic data is collected and calibrated to an expected coordinated system of the user. The user may place the activity monitor device 100 in a variety of different positions or similarly wear a garment in a variety of positions. The calibration mode accounts for such positional variations. The user application 200 may guide a user through a set of instructions during the calibration mode. For example, the user application 200 may present an instruction to stand straight and not move for 5 seconds. The calibration mode is preferably initiated before a tracking mode. The calibration mode may be engaged once per use, but may alternatively be periodically engaged.

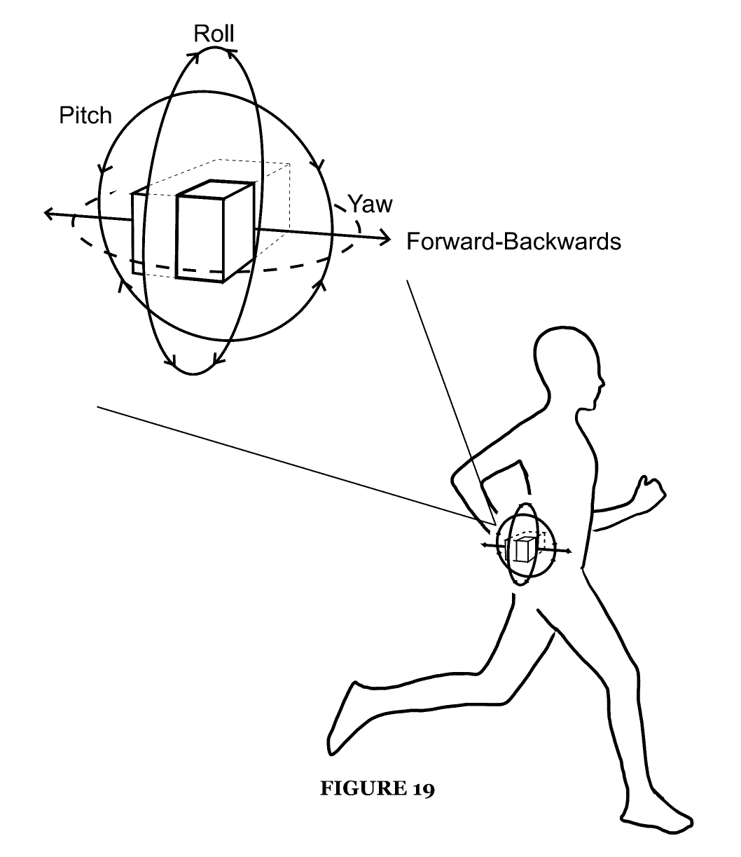

The calibration mode preferably converts sensor data so that acceleration and other kinematic properties are aligned to a coordinate system of the participant. The orientation of the activity monitoring device can be described in terms of yaw, pitch, and roll wherein a yaw axis is aligned with a defined up-down vertical axis (e.g., aligned with gravity), the pitch axis is aligned with an axis orthogonal to the left or right side-view of a participant, and the roll axis is generally aligned with the direction of motion (e.g., the forward/backward direction) as shown in FIG. 19. Adapting orientation of kinematic data sensing to participant orientation preferably calibrates the pitch and roll of how the activity monitoring device is affixed to a participant. Pitch is characterized as the tilt or more specifically the rotation in the sagittal plane. Roll is characterized as the drop or more specifically the rotation in the coronal plane. Depending on the design of the activity monitoring device, the pitch and roll can vary between uses. Adapting orientation can additionally calibrate yaw. Yaw is characterized as the rotation of the activity device and more specifically the rotation in the transverse plane. Yaw is more preferably classified in one of two orientations with an activity monitoring device facing forward or backwards when the activity monitoring device is structurally designed to orient in one of two directions. The physical design of the housing preferably promotes such a biased orientation of the activity monitor device. In one implementation, the biased orientation can bias at least one axis in one or two directions (i.e., a binary option of orientations). Other variations, may promote activity monitoring device oriented in only one standard direction wherein that yaw orientation can be assumed. Similarly, pitch and roll can be biased in one or more orientations. In one example, the use of a horizontal pocket and vertical attachment clip may be used to bias the orientation of the activity monitor device 100 in eight orientations as shown in FIG. 20. Other suitable orientation biases may be used. In one variation, the garment electrical interface may electrically detect the coupled component (e.g., a type of garment or attachment) and use this in adjusting calibration.

The system can additionally include a signal processor module. The signal processor module functions to transform sensor data generated by the inertial measurement device. The signal processor can be operative within a processing unit of the activity monitor device 100, the user application 200, or in the data platform 300. In one variation, the signal processor module may be distributed such that more than one device include a portion of the signal processor module. The signal processor module may include a step segmenter, a calibration module, a ground contact monitor, a cadence monitor, a vertical oscillation monitor, a pelvic rotation monitor, and a pelvic drop monitor, and/or any suitable biomechanical signal monitor which functions to output a set of biomechanical signals. Additional or alternative biomechanical signals may be used. The signal processor module can be integrated with the activity monitor device. The signal processor module may alternatively be application logic operable within the user application 200. In yet another variation, the signal processor module can be a remote processor accessible over the network. For example, biomechanical signals may be generated in the cloud, which functions to provide remote processing.

The system may additionally include a data platform 300, which functions to host collected data. The user application 200 preferably transfers activity data to the data platform 300. The data can be transferred during a run, after completion of a run, periodically, or at any suitable timing. The activity data can be kinematic data from the IMU, biomechanical signal data, logical interpretations of the biomechanical signals (e.g., coaching state), and/or any suitable activity information. For example, the classification of various running patterns as determined by a biomechanical running logic model can be stored in the data platform 300. The system may additionally or alternatively be integrated with one or more external platforms. For example, activity data can be sent to a third party service via an API. The data platform 300 preferably collects data from a plurality of distinct participants. The data platform 300 may be configured with analysis processes that can be applied to an individual participant's activity data history and/or multiple participants' activity data history. In one variation, the activity data can be collected along with geospatial metadata that relates a set of activity data to a particular geospatial property. The data platform 300 can generate a biomechanical-geospatial mapping for one participant or across multiple participants. This can be applied to understand how the biomechanics of an activity are impacted in different regions. The geospatial properties can include a geographic location (e.g., longitude and latitude obtained from a GPS or other location service), the elevation, the terrain type, or any suitable location information. Alternatively or additionally, other forms of activity metadata can be collected such as weather. Biomechanical-geospatial mapping could be applied to how the biomechanical signals are calculated. For example, particular biomechanical signals such as vertical oscillation may be calculated differently in bumpy terrain where many participants report higher than usual vertical oscillation. Biomechanical-geospatial mapping may additionally or alternatively be applied to generating feedback for a participant. While coaching a particular biomechanical signal, the biomechanical-geospatial data can be used to determine a recommended running route. The data platform 300 additionally stores activity data history along with provided or collected demographic information, geographic information, goal oriented information, and/or other contextual information. Contextual information to activity data can be used in performing group analytics. The data platform 300 may also be used to provide longitudinal analysis of a specific user to provide more relevant coaching, goal tracking, and/or other features to the system.

### 3. Method for Use of an Activity Monitor and Application

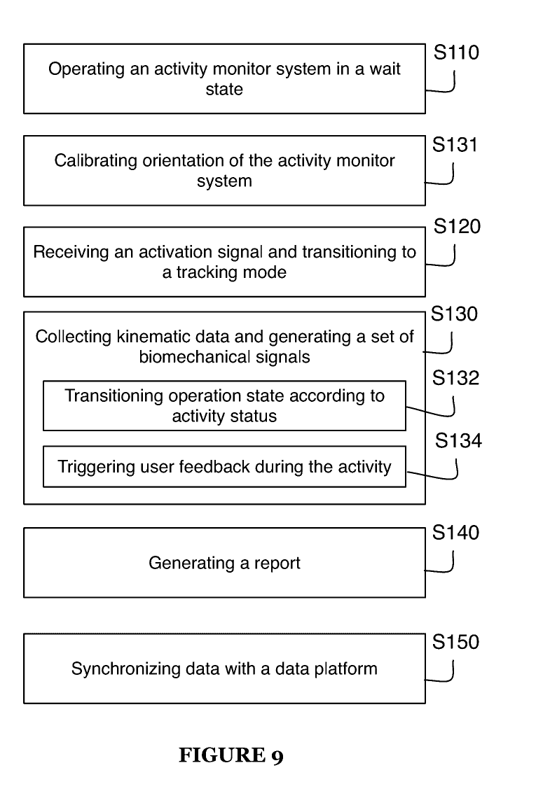

As shown in FIG. 9, a method for use of an activity monitor and application can include operating an activity monitor system in a wait state Silo, receiving an activation signal and transitioning to a tracking mode S120, collecting kinematic data and generating a set of biomechanical signals S130, and generating a report S140. The method preferably provides an interaction and control process for a wearable activity-tracking device. The method preferably utilizes integration with a biomechanical based tracking device to augment feedback during an activity session. The biomechanical based tracking device can be integrated with an enhanced garment, a clip attachment, or use any suitable mechanism to affix to a user and/or garment. Additionally or alternatively, a method for use of an activity monitor and application can comprise operating an activity monitor system S210 which includes generating a set of biomechanical signals from kinematic data of an activity monitor system S212 and communicating the set of biomechanical signals to the application S214 and dynamically augmenting the operation of the activity monitor system according to at least one factor S220, which may involve adjusting generation of biomechanical signals and/or adjusting the communication of the biomechanical signals based on factors such as communication signal strength or duration of an activity.

Preferably, the activity monitor device can provide sufficient battery life for practical use as well as provide useful biomechanical signal insights. As one potential desired design characteristic, a battery of the activity monitor system is preferably of a small volume so that the activity monitor can be lightweight and small. As another potentially desirable design characteristic, the general battery life of the activity device from a full charge should be able to track activity over the full duration of an activity session and preferably multiple activity sessions. The battery life may require monitoring an activity over short periods and/or long multi-hour periods. As another potentially desired design characteristic, the end data resolution of the activity monitor device should be sufficiently high and preferably reported in substantially real-time (e.g., less than 30 second delay). The kinematic data resolution may have a high minimum data value frequency (e.g., higher than 50 Hz and in some cases greater than 90 Hz). The high minimum value frequency may be desirable to generation of biomechanical signals. As yet another potential desired design characteristic, the activity monitor device should communicate wirelessly to a user application on a distinct computing device (e.g., a smart phone or smart watch). In one implementation, the activity device can generate the biomechanical signals on device to provide high quality data. Dynamic adjustments to how the biomechanical signals are generated can address communication and battery life challenges. Similarly, various techniques in operation of the system can promote extended battery life.

The method can be applied to a running or walking session but may alternatively be applied to any suitable use-case. The method is preferably implemented by a system substantially similar to the one described above. The method preferably includes operation of an activity monitor device, a user application, and optionally a data platform. The method may alternatively be implemented by any suitable alternative system.

Block Silo, which includes operating an activity monitor system in a wait state, functions to have an activity-sensing device in a non-active operation mode. Operating an activity monitor system in a wait state preferably sets the activity monitor device (i.e., the sensing device) in a low energy sleep mode. The activity monitor device may periodically wake and check various aspects. There can be various levels of a wait state such as a deep sleep mode and ready mode. A sleep mode may only collect kinematic data every few minutes. A ready mode may collect and analyze kinematic data but limit communications. As described in block S120, the activity monitor device can be responsive to an activation signal, which can interrupt a wait state. The wait state can be engaged when the activity monitor device is not attached to a garment. When not attached or positioned for an activity, the device may be in an inactive mode that provides further energy conservation measures. When the activity monitor device is “docked” to an enhanced garment or otherwise attached for an activity, the wait state may include monitoring for an activation signal. Similarly, detected movement can be used to put the activity monitor in an active state. The activity monitor device may detect when the device is attached to an enhanced garment by detecting an electrical connection through a garment electrical interface 140 of the activity monitor device.

Block S120, which includes receiving an activation signal and transitioning to a tracking mode, functions to prepare the activity monitor system for collecting and/or analyzing an activity. The tracking mode can include active collection of kinematic data and conversion to biomechanical signals. An activity signal can be triggered through a variety of events. An activation signal may originate from an enhanced garment or attachment, from connected user application, or from detection of particular activity patterns or movement. In one variation, any movement or change in orientation can be used to wake up a device.

In a first variation, receiving an activation signal includes detecting an electrical connection change through the garment interface of the activity monitor device. The electrical change may be a binary voltage change, which may result from activation or deactivation of a switch or button integrated with the enhanced garment. For example, a button may be conveniently located on the garment, and when the button is pressed an activation signal is received through the garment interface. The electrical change may alternatively be a variable voltage change. In yet another variation, a message can be communicated over the garment interface using any suitable communication protocol. While the garment interface of the activity monitor system can be used to conductively couple with an enhanced garment, the garment interface may alternatively be used to conductively couple with any suitable device such as clip attachment with an integrated button.

The garment interface of the activity monitor device is preferably a non-rigid conductive interface that may rely on structural features of a garment to apply a force promoting contact with conductive pads of the activity monitor device. In some instances, the conductively coupling may be disturbed. In one instance, contact may be non-continuous. In another instance, sweating may result in shorting of the conductive pads of the activity monitor device. Receiving an activation signal can include verifying validity of an input signal of the garment interface. A signal validation process could distinguish between true signal inputs from disturbances caused from non-continuous contact or shorting.

In a second variation, receiving an activation signal includes receiving a communication from a user application. The user application may generate an activation signal and transmit it over a communication channel to the activity monitor device. The user application may generate an activation signal in response to user input, application logic, or a remote trigger from the data platform.

In a third variation, receiving an activation signal includes detecting activity through periodic activity tracking. The activity monitor device can periodically collect kinematic data. The kinematic data is preferably used to generate a set of biomechanical signals as in Block S130. If biomechanical signals can be generated that match an activity signature or any suitable condition, the activity monitor device transitions out of the wait state. If no biomechanical signals can be generated or the generated signals indicate a low probability that a particular activity is being performed, the activity monitor device can go back to a sleep state. Additionally or alternatively, the activity monitor device may transition out of a wait state on any motion or orientation change above a set threshold. For example, if a user is driving in a car, the activity monitor system may be in a sleep state or other power-conserving mode. When the user gets out of the car and starts walking or running, the activity monitor system may wake up and enter a tracking state or a ready state. Similarly, the activity monitor device may be able to automatically transition out of a wait state when a user switches from walking to running. The activity monitor system may differentiate between running and other activities such as walking, jumping, and other activities. For example, a user could wear the activity monitor system while doing a series of exercises, but the activity monitor system can automatically transition out of the wait state when running is detected. The biomechanical signals generated during the wait state may be collected over a limited period of time and at a low frequency. For example, a ten second sample may be collected every five minutes.

The method can additionally include calibrating orientation of the activity monitor system S131, which functions to correct for positioning of the activity monitor device. As discussed, the system and method may enable non-rigid mechanical coupling with an enhanced garment, which functions to make the wearable technology more wearable. The physical coupling of the activity monitor device and the corresponding garment interface can limit physical motion of the activity device, and calibrating orientation can account for variability in position. In one implementation, a flat or rounded activity monitor device may be positioned with any suitable rotation about an axis. The calibrating orientation preferably transforms the coordinates of kinematic measurements from an IMU coordinate system to a coordinate system with one vertical axis substantially aligned with gravity, a forward axis aligned with the direction of running, and a lateral axis running left to right. Calibrating can additionally include determining sensor location, activity, or other suitable usage context through a sensing algorithm, application logic, user input, or other suitable inputs.

Block S130, which includes collecting kinematic data and generating a set of biomechanical signals, functions to translate sensor data into a biomechanical interpretation. Kinematic data is preferably collected at an activity monitor device. The kinematic data is preferably included for generating one or more biomechanical signals. Processing of the kinematic data may alternatively be performed in part or in whole on the user application. The biomechanical signals for an activity are preferably a substantially real-time assessment of the biomechanical properties during the activity, and, as such, the biomechanical signal can be a time series data set. The biomechanical signals may be condensed to a consecutive step average, an average value, an average range, a full range, or any suitable characterization of biomechanical signals from an activity session.

Collecting kinematic data is preferably performed when the activity monitor system is positioned in the waist region. More specifically, the activity monitor device can be positioned along the back in the lumbar or sacral region. In another variation, the activity monitor system uses a multi-point sensing approach wherein a set of inertial measurement systems measure motion at multiple points. The points of measurement may be in the waist region, the upper leg, the lower leg, foot, upper body, the head, portions of the arms, or any suitable point. The activity monitor system may alternatively use any alternative approach to sensing and collecting kinematic data. The data collected by the activity monitor system is preferably data from a 9-axis motion-tracking inertial measurement unit as described above, but any suitable sensor or sensors may be used.

With the activity monitor in a waist region, a set of biomechanical signals is preferably generated that characterize the step properties of a locomotion activity (e.g., sprinting, running, jogging, or walking). The biomechanical signals can provide step characteristics broken down by step. Additionally, a biomechanical signal could be classified by the leg performing the action. In one implementation, the biomechanical signals can include cadence, ground contact time, braking, pelvic rotation, pelvic tilt, pelvic drop, vertical oscillation of the pelvis, forward oscillation of the pelvis, forward velocity properties of the pelvis, step duration, stride length, step impact, foot pronation, foot contact angle, foot impact, body loading ratio, foot lift, motion paths, and other running stride-based signals. Additionally, the biomechanical signals can include left/right detection, which may be applied for further categorizing or segmenting of biomechanical signals according to the current stride side.

The generated set of biomechanical signals are preferably generated by a processing system of the activity monitor system and communicated to the user application. A record of the kinematic data and/or biomechanical signals may be stored locally on the activity monitor system. The user application preferably stores the biomechanical signals and/or synchronizes the communicated data to a remote data platform.

The biomechanical signals are preferably recorded along with additional activity information such as speed, location, activity timestamp, heart rate, and/or any suitable information. In one variation, the biomechanical signals may only be recorded when they satisfy an activity status threshold. For example, the biomechanical signals can be generated while a user is walking, but recording of data starts once the activity status indicates the user is running. The activity status can be based on the biomechanical signals and/or other detected activity properties such as speed based on GPS and/or location services.

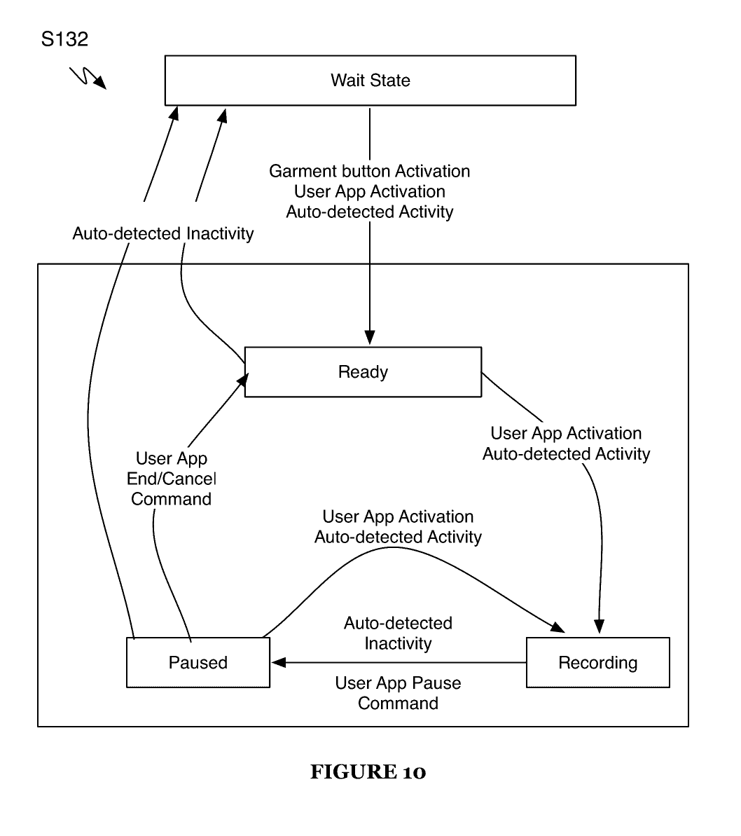

The method may additionally include transitioning operation state according to activity status S132, which functions to use the activity of a user to change the operational state of the activity monitor device and/or user application as shown in FIG. 10. Preferably, transitioning operation state is used to pause and/or resume recording of the biomechanical signals. Other application logic may be augmented by detected activity status changes. For example, when a runner stops in the middle of a run, the user application may pause recording of an activity, display a “paused” screen, pause the played music, and play an audio instruction to indicate that the run has been paused. In one variation, an audio message providing information about the activity can be played when a user stops the activity. For example, during a run, a user may stop running to rest or hydrate, the operation state can automatically transition such that an audio message may read out to the user the current run time and distance and list recent biomechanical metrics. When the user begins to run after a short break, the length of the break may be recorded, the music may restart, and recording of the biomechanical signals and activity information can resume.

The method can additionally include triggering user feedback during the activity S134, which functions to provide coaching and guidance to a user. Triggering user feedback can include displaying an alert, playing an audio message, activating a haptic feedback element, or performing any suitable form of user feedback. For example, an alert may be flashed on a smart watch, an audio message may be played through a user's headphones, or a haptic feedback device (e.g., a feedback device on a garment connected through the garment electrical interface 140 of the activity monitor) can be activated. In one variation, a performance audio indicator can be used as non-verbal indication of performance status. A performance audio indicator can provide contextual information as to how one or more activity properties relates to a target level. In one implementation, a rhythmic tone can be played in beat with played music. In one implementation, the rhythmic tone is on beat if the associated performance metric is on target. If the rhythmic tone is slower, the performance metric is below the target value, and if the rhythmic tone is faster, the performance metric is above the target value. In another implementation, a first tone can be played when recent biomechanical signals are satisfying a performance goal and a second tone can be played when the recent biomechanical signals are not on target to satisfy a performance goal. This may be used when a user is trying to improve a particular biomechanical property of his or her running stride. Any suitable audio or visual cue may be used.

Triggering user feedback preferably includes analyzing the biological signals according to a set of threshold settings. The user feedback is preferably in response to an event detected by a biomechanical logic model, which can define the analysis process. The analysis can be monitoring one or more threshold conditions. The threshold condition can be used in triggering a particular alert when a subset of biomechanical signals and other parameters satisfy a particular condition. For example, an audio message can be played when a user's ground contact time signal goes above a particular threshold. The analysis may additionally use more sophisticated analysis looking at properties of the user, the environment, performance history over multiple activity sessions, and progress within a current activity session. For running, a biomechanical running logic model can process the biomechanical signals and determine particular characteristics that a user should modify during a run such as adjusting their stride rate, posture, or other stride characteristics. In another variation, machine learning or other artificial intelligence can be applied to customize the various sets of parameter thresholds in the biomechanical logic model depending on previous run history, user demographics, running style, behaviors, performance results, and/or other suitable aspects. The machine learning can also prioritize which biomechanical metrics need improvement. For example, machine learning can be used in identifying which aspect of an activity to monitor for feedback based on the unique properties of usage. Various forms of user feedback can be triggered in response to the analysis of the biological signals.

In one variation, user feedback may be customized to focus on a subset of activity properties. The customization preferably occurs after completion of one activity session, where an issue with a particular aspect of the activity is highlighted. For example, the user application may inform the user that the pelvic tilt of the user's stride is higher than an ideal value; the user can activate a pelvic rotation coaching mode to receive automatic user feedback during a subsequent run as shown in FIG. 8B. The user feedback may alternatively be automatically determined without customization by a user. As described below, a method for automated coaching of running kinematics maybe be used when triggering user feedback S134.

Triggering user feedback during the activity can additionally or alternatively include triggering user feedback in response to an activation signal received through a garment interface. The activation signal received through a garment interface will preferably be initiated by an interaction with a garment user interface element. For example, when a user presses a button integrated in the garment, user feedback can be triggered. The received activation signal may be substantially similar to the one used in transitioning the activity monitor system out of a wait state. If, for example, a user wants to hear their current activity status when on a run, the user presses a button on their running pants, the activity monitor device detects this activation signal and communicates with the user application, and a message is played reading out his or her current activity status.

Block S140, which includes generating a report, functions to present an activity summary from an activity session. The report preferably summarizes aspects of an activity and/or provides a historical record or analysis of the activity. The report can be continuously updated. For example, a user may be able to access the user application at any point during a run to view a current report. The report may alternatively be generated upon completing an activity session. For example, after a user completes a run, a report can be generated and displayed in a user application. In one variation, machine learning or other artificial intelligence can be applied to the particular user or across the entire population of users to customize report generation for a particular user that may include insights and social comparison data. The machine learning can additionally be applied to the type and/or form of user feedback. The report is preferably a graphical interface presentation, which may be static or interactive. The report may include key metrics, a timeline view, a map view, feedback messages, and/or any suitable information as shown in FIGS. 8A-8D. The report can additionally or alternatively be delivered as an audio message or in any suitable medium. Preferably, report information for an activity session can be stored and viewed as a historical record. In one variation, a report may include a comparison of a current activity session to at least one previous activity session.

The method can additionally include synchronizing data with a data platform S150. Activity reports and/or other activity information (e.g., activity sensor data, biomechanical signals, activity status events, and/or other information) can be transmitted to a remote data platform. The remote data platform is preferably a cloud-hosted platform. Another account instance of the user application may be synchronized with a first account instance through the data platform. Additionally, the data platform can be used in synchronizing firmware versions, software updates, algorithm updates, and/or other system updates.

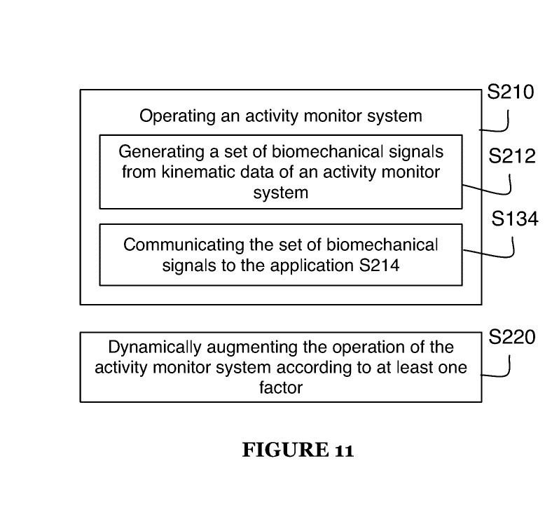

As mentioned above, an additional or alternative method for use of an activity monitor system can include operating an activity monitor system S210 including generating a set of biomechanical signals from kinematic data of an activity monitor system S212 and communicating the set of biomechanical signals to the application S214 and dynamically augmenting the operation of the activity monitor system according to at least one factor S220 as shown in FIG. 11. The method is preferably applied for dynamic processing and/or communication of biomechanical signal data to a second computing device.

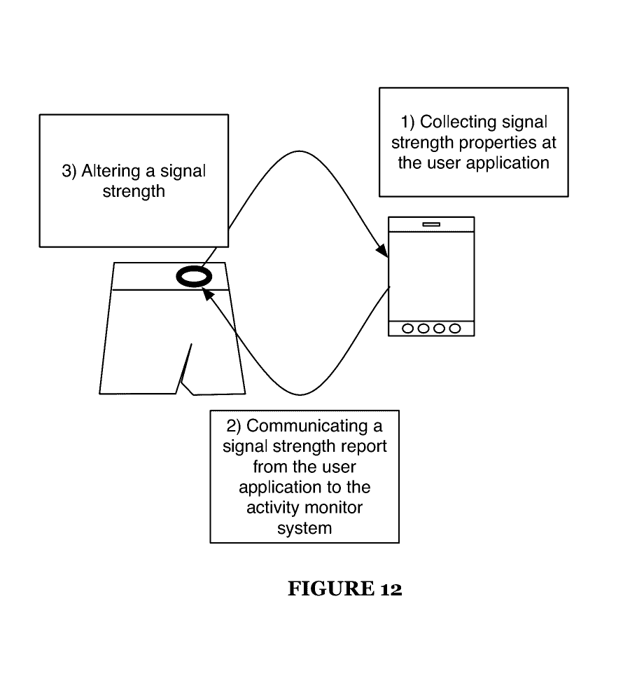

As shown in FIG. 12, the method may be used for dynamically adjusting or augmenting the communication mode of the activity monitor device which can include collecting signal strength properties at the user application and/or at the activity monitor device. When detected at the user application, the user application can communicate a signal strength report from the user application to the activity monitor system. The signal strength report may include the signal strength value, but may alternatively include a request to change the transmission strength of a communication module of the activity monitor system. In response, the activity monitor system can augment the transmission strength of data to the user application. The transmission can be increased when the signal is weak and decrease or maintain the transmission level if the signal is sufficient or overly strong. In one instance user properties and tendencies may result in a weak signal. The body proportions and/or the positioning of the activity monitor system and a computing device of the user application may impact the signal strength. Consistent communication problems for a participant may be classified as participant interference and the user application may prompt the participant on altered device positioning. For example, a participant may be prompted through an onscreen alert that improved system performance can be achieved by mounting the smart phone of the user application closer to the activity monitor system or on the same side of the body. In another instance environmental conditions can alter communication signal strength. Open spaces may have fewer objects for signal reflection for example. The communication signal properties may be mapped using data collected from one or more participants. The activity monitor device and/or user application can use historical and geographic information of signal strength to predictively adjust signal strength. In one variation, the method can include collecting signal strength properties from multiple participants and mapping the signal strength properties to geographic locations. For example, a participant may run towards a region that has previously consistently had poor communication signal strength. The signal strength could be pre-emptively increased before or as the participant approaches that region to avoid signal loss or disconnection of the activity monitor system from the user application.

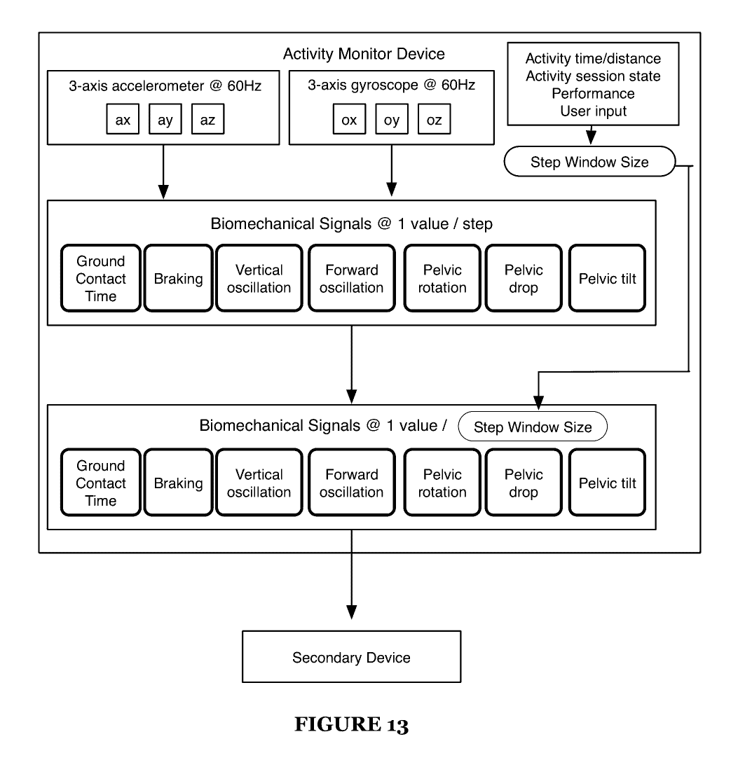

As shown in FIG. 13 the method may be used in adjusting the generation of biomechanical signals. The biomechanical signals and how they are processed or organized can impact processing requirements, data communication requirements, power consumption, and/or other aspects of operating the activity monitor system. A value of a biomechanical signal preferably characterizes a biomechanical property of at least one step. In one instance, that value may be directly mapped to one particular step of the participant. Alternatively, a biomechanical signal value can map to a set of steps such as a window of consecutive steps by an alternating or the same leg. The window of consecutive steps preferably provides averaging and consequential reduction in the effects of random error for an individual step value. The method can include adjusting a step segment window size for a biomechanical signal value. A larger window size may reduce the amount of data to communicate which may reduce the number or frequency of transmissions and/or the amount of data communicated in a transmission. Additionally or alternatively, dynamic monitoring can be used to alter resolution across an activity session wherein generation of biomechanical signals (and corresponding collection of kinematic data) may include dynamically generating the set of biomechanical signals at intermediate intervals. The intermediate intervals could be at regular or irregular periods. Alternatively, the activation and deactivation of biomechanical signal monitoring could be dynamically controlled at each activation/deactivation transition. When deactivated, the activity monitor device can be in a rest mode. Collection of kinematic data can be halted during the rest mode of the activity monitor device. The rest mode can be used while the user is active as an approach for conserving power by decreasing the use of the sensors, processing, and communication resources of the activity monitor device. In some variations, individual biomechanical signals may be dynamically generated independently of each other such that one biomechanical signal could be continuous while another one is only periodically monitored.

In one variation, the step segment window size can be adjusted and/or the periodic monitoring of biomechanical signals engaged based on run distance or desired resolution of the biomechanical signals. The resolution of biomechanical signals in a long run may be made lower when compared to the resolution of a short run. Accordingly, the step segment window size may be increased with the current distance or duration of an activity session. Similarly, periodic monitoring of biomechanical signals may be activated during long activity sessions. The biomechanical signals may be collected periodically with the rest period duration set proportionally based on the current or expected duration of the activity session.

In another variation, the step segment window size can be adjusted and/or the periodic monitoring of biomechanical signals engaged based on biomechanical signal performance. The resolution of biomechanical signals that are consistently within a target range may be made lower than those that do not satisfy a target. For example, a runner with good form may have biomechanical signals averaged over a larger step segment window (e.g., over one minute), and a runner with poor form may have biomechanical signals averaged over a smaller step segment window so that more refined coaching and feedback can be provided. In another example, the biomechanical signals may not need continuous monitoring when a participant is consistent and/or meeting performance goals, and periodic monitoring of biomechanical signals may be engaged. If the biomechanical signals are detected to change or drift away from a target goal, biomechanical signals may be monitored continuously, for long durations, and/or more frequently.

In another variation, the step segment window size can be adjusted and/or the periodic monitoring of biomechanical signals engaged based on activity session state. The activity session state can include the location of the activity, the current progress state within a planned activity session, or other suitable properties. In one example, the resolution of the biomechanical signals can be at one setting at the beginning and end of the activity session and the resolution can be at a second setting in the middle. Preferably, the first setting is a higher resolution setting with a small step segment window size and/or with continuous or more frequent biomechanical signal monitoring. The beginning and end of the activity session can be determined based on proximity to a start and/or end position. The beginning and end of the activity session can be determined based on a planned run distance or time.

In another variation, the resolution of biomechanical signals may be fully or partially controlled by user input. For example, a user may configure a setting to collect data with a small step window. In one particular implementation, the resolution of biomechanical signals may be altered based on user input received through a garment interface of the activity monitor system. The user input could be a button activation made within an enhanced garment. For example, while running, a user may press a button to receive coaching or an update on current biomechanical signals. The resolution of the biomechanical signals may be increased so that an accurate report of current biomechanical signals can be reported through audio, displayed information, or any suitable feedback format.

In another variation, a first subset of biomechanical signals may be calculated with a first resolution while a second subset is calculated with a second resolution. For example, a biomechanical signal that is currently a training focus may be generated with higher resolution compared to other biomechanical signals. In one case, a subset of biomechanical signals may not be calculated.

### 4. Method for Automated Coaching of Running Kinematics

The system and method herein can enable the collection and use of biomechanical data for analyzing an activity and in particular a running or walking activity. Having real-time visibility into the technical aspects of how a user is running enables feedback that goes beyond high-level performance metrics such as time and speed. The options for providing user feedback can be highly varied. In one variation, a method for automated coaching of running kinematics can be used that applies a progressive and adaptive approach.

A system and method for automated coaching of running kinematics functions to provide reactive feedback on how an individual is running. The system and method preferably detect and analyze the biomechanical properties of how an individual is running, and then generate feedback and coaching advice based on those physical properties. The system and method preferably prioritizes the focus of a training session to a limited set of biomechanical running signals. Preferably, a participant is coached on a single running characteristic during an activity session and progressively coached in subsequent activity sessions on other characteristics depending on the biomechanical performance of the participant. Through repeated use, the system and method can sequentially address the various issues in the individual's running form. The system and method is additionally adaptive in that a beginner or an advanced runner can improve running style and performance with customized training.

The system and method preferably include detection of a set of biomechanical signals. In one preferred implementation, training focus is prioritized by cadence, pelvic rotation, vertical oscillation, braking, pelvic drop, pelvic rotation, and ground contact time from highest to lowest priority. Additional or alternative biomechanical properties could similarly be prioritized.

In practice, a participant will go on one or more runs. The biomechanical signals for those runs will be tracked and recorded. There will generally be a subset of the biomechanical signals that will be outside the target range. The biomechanical signals preferably have different target ranges, wherein the target ranges are the values typical of a runner with good form. The target ranges can vary based on demographics, run classification (e.g., track, road, hills, or trail), level of the participant (e.g., beginner, intermediate, expert, etc.), and other properties. The biomechanical signals that need work are then prioritized and the highest priority biomechanical signal is the initial training focus. Biomechanical properties are preferably prioritized according to predetermined priority values, but may alternatively be prioritized according various factors such as demographics, level of the participant, coaching history, the severity of problems with biomechanics, and/or other factors. The system and method use a focused training approach so that a participant can work on improving a limited number of running traits during a given activity session. Focused training is preferably for a single biomechanical signal, but there may alternatively be a variable number of training focuses for a single activity session.

In one example, the system may determine over one or more running sessions that a runner may need to improve cadence, braking, and drop. For the next activity sessions, the runner will be coached on cadence, until the cadence signal is within a target range. Changing one running characteristic may alter other characteristics, in which case the system and method prioritize the next coached running property based on the new problems. If braking and drop remain out of the target range and cadence is in the target range, then braking may be selected as the training focus. If a runner does not satisfy a target after set number of runs, coaching may move to a new coaching focus. When the biomechanical signals are within their respective target ranges, the coaching advice can focus on performance improvements such as coaching for distance and/or speed. The system and method preferably balance biomechanical signal patterns and performance.

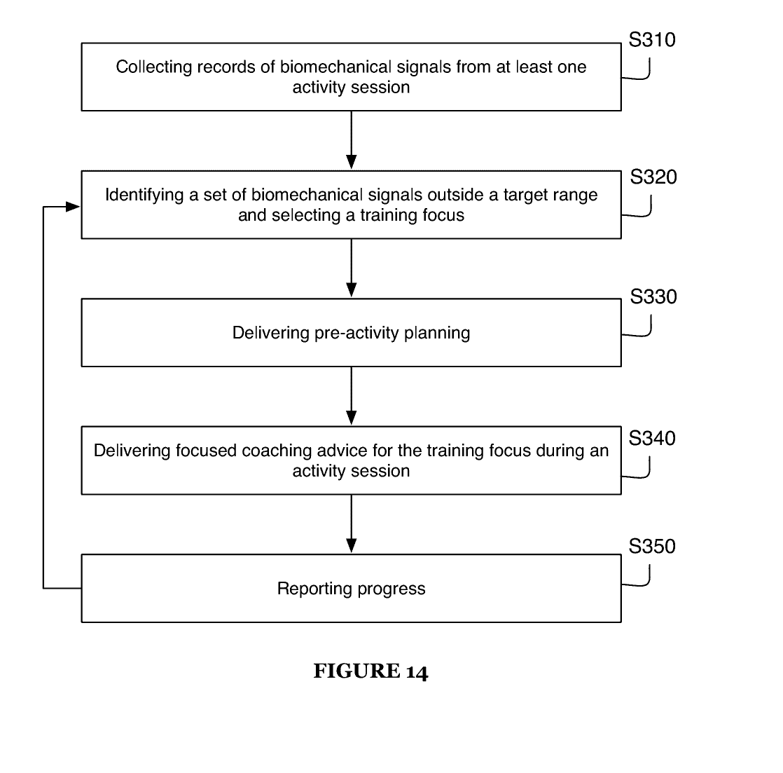

As shown in FIG. 14, a method for automated coaching of running kinematics can include collecting records of biomechanical signals from at least one activity session S310, identifying a set of biomechanical signals outside a target range and selecting a training focus S320, delivering coaching advice for the training focus during an activity session S340, and reporting progress S350. Additionally, the method can include delivering pre-activity planning S330. The method is preferably used in limiting training focus of a current activity to a single biomechanical signal and target. Through continued training and implementation of the method, a participant can incrementally improve form and performance. The focused approach to feedback delivery of the method functions to address running form issues so as to potentially enhance impact, motivate the participant, and maintain healthy training practices. The method preferably prioritizes the biomechanical signals with the sequence of: cadence, pelvic tilt, bounce, braking, drop, rotation, and ground contact time. In the basic approach, a participant will work to get each of the biomechanical signals into a target range. Focused training can be reestablished if one or more of the biomechanical signals falls outside of the target range again. The prioritization and logic for selecting a training focus can include any suitable logic. For example, some biomechanical signals such as ground contact time may only be suitable as a training focus for experienced runners. Various training programs can be offered that may augment how a training focus is determined. Training programs may be categorized by running goals, participant experience, or other suitable categorizations.

Block S310, which includes collecting records of biomechanical signals from at least one activity session, functions to determine the parts of an individual's running form that may benefit from training. Collecting records of biomechanical signals preferably includes collecting kinematic sensor data and generating biomechanical signals as described herein. In one variation, the method is performed based on the most recent activity session. For example, the most recent run can be used to determine the coaching of the next run. In another variation, the combined analysis of previous runs can be used. In using a plurality of previous runs, the biomechanical signal values and trends can be used. The biomechanical signals may be condensed to a consecutive step average, an average value over an activity session, a value range within some window, or any suitable characterization of biomechanical signals from an activity session.

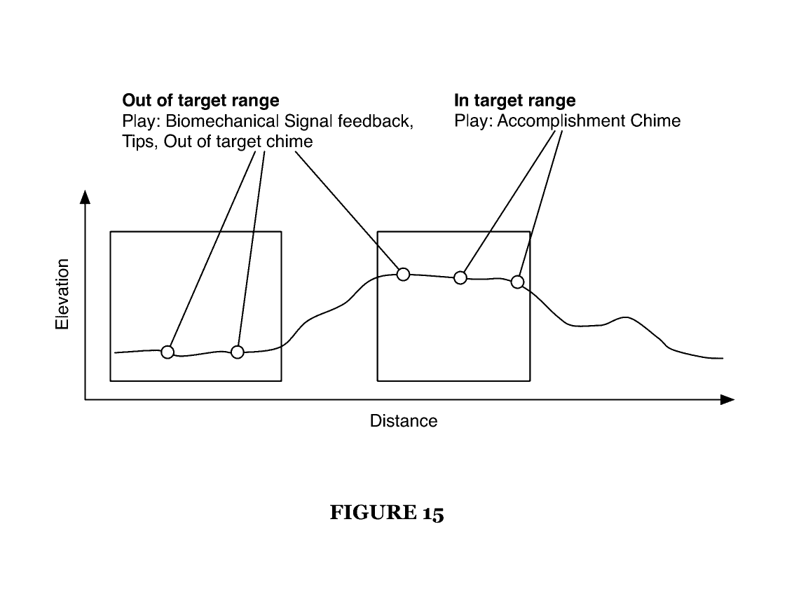

As one aspect, the method may be limited to training for a particular type of run. For example, the method may only base subsequent coaching on data from runs completed on generally flat paths (such as a track). Types of runs may include track, road, hill, trails, and other sorts of runs. Similarly, a run may alternatively or additionally be classified by distance goals. In one variation, the participant can specify the type of run. In another variation, the method can include automatically classifying a run. For example, the GPS-detected path of a run can be correlated with mapping information to determine the elevation changes and ground surface type. Similarly, delivering coaching advice may be delivered only when the participant is performing a similar run to the run(s) on which the coaching is based. For example, audio coaching advice may not be played or stop playing if it is determined a participant is doing lots of hill running while the training is set for track running. As shown in FIG. 15, delivering of coaching can additionally dynamically determine portions of a run where coaching can be delivered.

Automated coaching can be applied to a variety of biomechanical signals. For running, step characteristics may be broken down by step, step windows, and/or leg steps (e.g., left or right steps). The set of biomechanical signals for running preferably includes cadence, pelvic tilt, vertical oscillation, braking, pelvic drop, pelvic rotation, and ground contact time. The set of biomechanical signals may additionally or alternatively include forward velocity properties of the pelvis, step flight time, stride length, foot pronation, foot contact angle, foot impact, body loading ratio, foot lift, motion paths, and/or other running stride based signals.

Block S320, which includes identifying a set of biomechanical signals outside a target range and selecting a training focus, functions to determine what aspects should receive training. The method preferably selects a single aspect for training during a given activity session. For example, the method will only deliver coaching advice for cadence until cadence is within a target range. In one variation, identifying a set of biomechanical signals outside a target range includes classifying the biomechanical signals into at least three categories that essentially correlate to poor, acceptable, and good. Each biomechanical signal will have different thresholds that determine the category of each signal. For example, the classification ranges for cadence can be less than one hundred and sixty-nine is poor, one hundred and seventy to one hundred and seventy-nine is acceptable, and above one hundred and eighty is good. In the case of a motion path and other biomechanical signals that can't be characterized by a single number, a target pattern can be used in place of a target range. The method preferably promotes improvement of each signal until the signal is in the good target range. However, if an individual only improves from poor to acceptable, the method may move on to training other biomechanical signals if, for example, improvement is not evident after several activity sessions. The progressive and focused coaching preferably facilitates keeping a participant motivated by guiding the participant to focus on aspects where progress can be made.

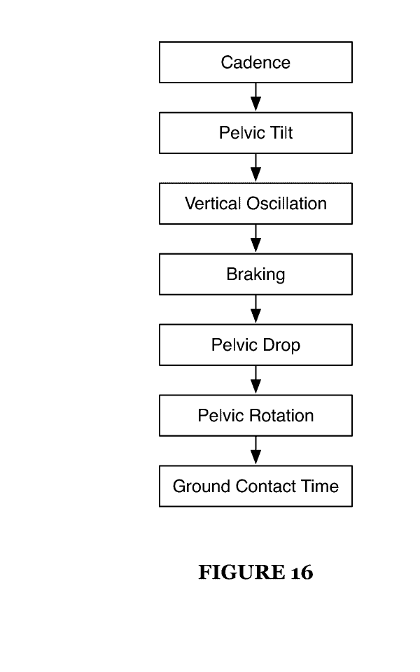

Selecting a training focus preferably includes selecting one of the biomechanical signals as a training focus according to an ordered prioritization of the biomechanical signals. One exemplary biomechanical signal prioritization is cadence, pelvic tilt, bounce, braking, pelvic drop, pelvic rotation, and ground contact time as shown in FIG. 16. In other words, cadence is the first biomechanical signal that will be selected for training focus if needed and ground contact time will be the last one selected as a training focus after all the other biomechanical signals are within the target range or if the runner has attempted each one for a specified number of runs. The order of biomechanical signal prioritization can be based on the amount of impact, the ease of correction, secondary improvements, health risks, and other considerations. Some biomechanical signals can provide significant improvements to the overall form. Secondary improvements are when improving a first biomechanical signal improves one or more other biomechanical signals.

The selection of the biomechanical signal as a training focus can use the most recent activity session as the reference for the participant's current status. Alternatively, any suitable logic or processing may be performed over multiple activity sessions. For example, the selection of the biomechanical signal may be based on the current status of each of the biomechanical signals, what biomechanical signal was previously selected, the amount of improvement for different biomechanical signals in previous activity sessions, and/or any suitable factor.

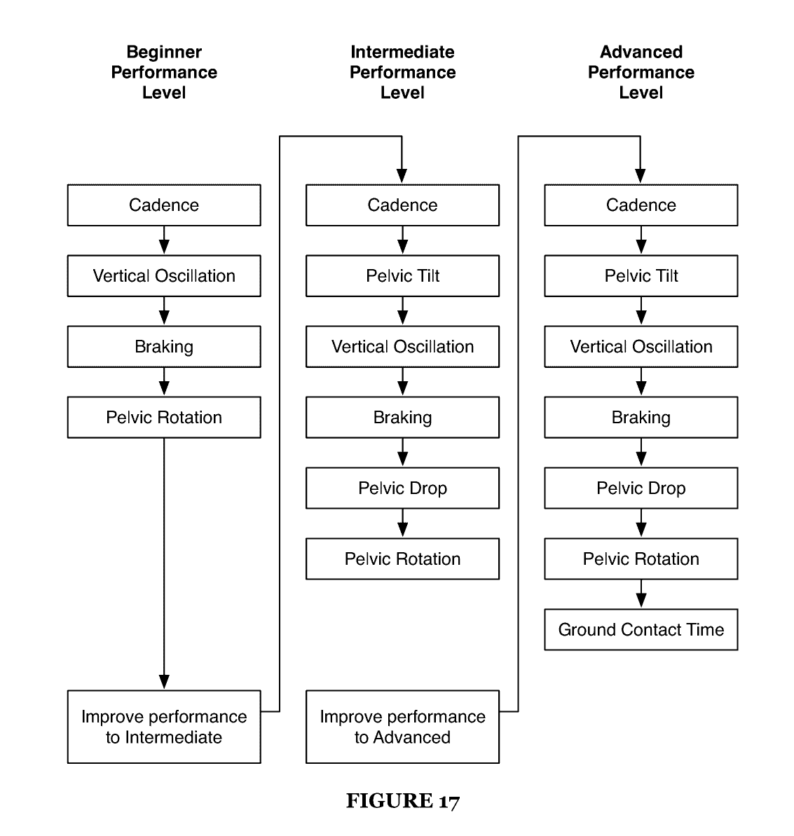

The selection of a training focus and the prioritization for the biomechanical signals may be based on current performance. The target ranges and other thresholds can vary depending on performance level. Additionally, some of the biomechanical signals shown in FIG. 17 may be reserved for advanced participants. If performance is not high enough then biomechanical signals that require more experience to be trained such as ground contact time or pelvic tilt may not be trained until performance increases. For example, a beginner may initially be coached with the biomechanical signal prioritization of cadence, vertical oscillation (e.g., running bounce), braking, pelvic drop, and pelvic rotation. After the participant has obtained good running form and potentially improved performance to a particular level, coaching for pelvic tilt and ground contact time may be enabled.

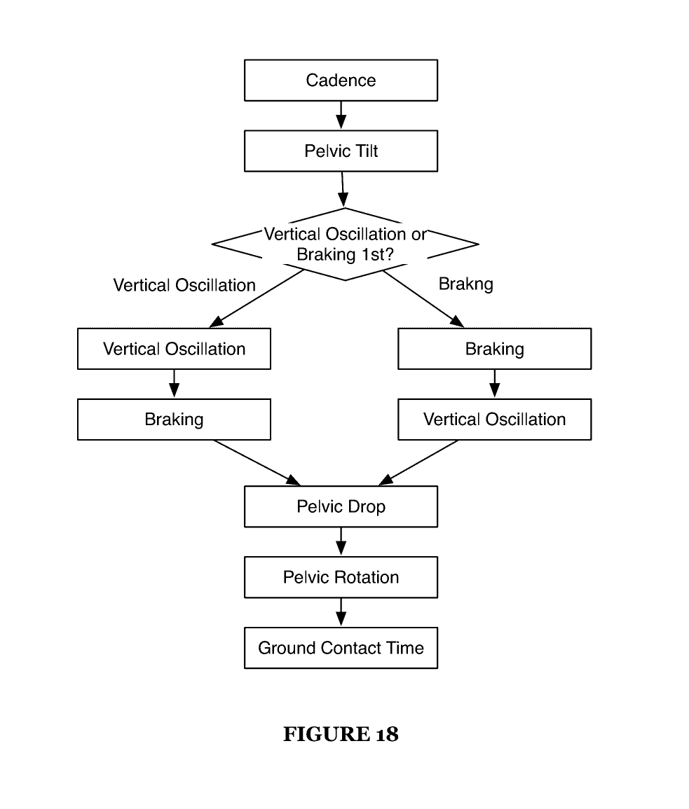

In another variation, the method can include partially using user input in selecting a training focus as shown in FIG. 18. For example, a participant could be presented with two training focus options. The options could allow a participant to manually change the training focus so as to skip training for a particular biomechanical signal.

Optionally, the method can include delivering pre-activity planning S330, which functions to prepare a participant or configure the system for an upcoming activity. Pre-activity planning can be delivered before a run or as a participant is beginning a run. The participant can be presented with the training focus for the upcoming activity session. Supplemental information, tips, animations/video/media, and/or other forms of content can be presented to the participant. The content could be displayed through an app, described through an audio cue, or delivered through any suitable medium. For example, if the participant will be focusing on bounce, then a description of the ideal bounce, how the participant's bounce relates to the ideal, and the target range during the next session can be presented to the participant.

Pre-activity planning can additionally include receiving user preferences such as a preference for the selected training focus, the number of training focuses, the type of run, coaching preferences, and/or other suitable information.

Block S340, which includes delivering coaching advice for the training focus during an activity session, functions to give feedback during a run. Block S340 additionally includes collecting biomechanical signals. The biomechanical signals are collected in a substantially similar manner to S310. The biomechanical signals are monitored until a feedback condition is satisfied. The feedback condition can be based on a time interval, a distance, or any suitable condition. The form of the coaching advice is determined based on the comparison of the biomechanical signal for the focused training and the target range of that biomechanical signal. If the biomechanical signal for that activity session is outside the target range, coaching advice can be communicated to the user. The coaching advice can be in the form of audio instructions, displayed text, a graphic, or any suitable form of feedback. The coaching advice can be current performance metrics, the current biomechanical signal values, and/or other metrics. The coaching advice can additionally include a tip or advice. If the biomechanical signal is within the target range, then positive feedback can be delivered. In one variation, the positive feedback can be in the form of a chime or brief audio signal, which functions to inform the participant that they met their goal without distracting them. In another variation, delivering coaching advice can include recommending one or more exercise recommendations, nutritional recommendations, equipment recommendations, and/or other recommendations. Exercise recommendations could be augmented based on fitness goals of the participant. Recommended exercises could include pre-run and/or post-run exercises.

Delivering coaching advice can additionally include adaptively limiting coaching, which functions to avoid burdening the participant when a goal can't be satisfied. The coaching advice can be limited after repeated failures to achieve the target range for a monitored segment of the activity session. One variation may offer a snooze feature for postponing tracking of a particular biomechanical signal. In a snoozing variation, after delivering coaching feedbacks a set number of times (e.g., after three attempts), the coaching advice may be delayed for another five minutes (or any suitable time or distance). In a back-off variation, the time and/or distance window for delivering coaching advice can be incrementally increased or decreased. For example, coaching advice can be delivered after each mile the first three times. Then the coaching advice may be incrementally be delivered after further distances such as after two miles, then three miles, and then five miles. Alternatively, the coaching feedback could end after a predefined number of coaching segments.

Block S350, which includes reporting progress, functions to provide follow-on feedback to the participant after completing a run. Reporting progress preferably includes presenting the progress made on the biomechanical signal selected for the focused training. If the biomechanical signal from the last activity session is determined to now be in the target range, then the participant can proceed to the next training focus in a subsequent activity session. The biomechanical signal data collected during S340 can be incorporated into the historical data of Block S310 and Blocks S320, S330, S340, and S350 can be repeated during the next run. As discussed above, a participant will progressively improve the varying aspects of their running form.

Reporting progress can additionally include recommending exercises, providing nutritional advice, recommending a product, and/or providing any suitable type of recommendation. Depending on the performance progress and biomechanical signal training progress, exercises can be recommended. The exercises can be different running-based training sessions, which may be guided from the system. The exercises may alternatively be non-running exercises. For example, various core exercises may be provided to aid an individual with correcting pelvic rotation. Product recommendations can be shoe, insole, or other suitable footwear recommendations.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system for tracking running activity comprising:
an activity monitor device that comprises:
an inertial measurement system,
a communication module,
a processor configured to generate a set of biomechanical signals from kinematic data collected from the inertial measurement system, and
a housing that internally contains the inertial measurement, the communication module, and the processor;
a user application operable on a second computing device distinct from the activity monitor device; and
wherein the communication module of the activity monitor device is configured to communicate the set of biomechanical signals to the user application.

2. The system of claim 1, wherein the set of biomechanical signals comprise the biomechanical signals of cadence, vertical oscillation, braking, pelvic drop, and pelvic rotation.

3. The system of claim 2, wherein the set of biomechanical signals comprise the biomechanical signals of left-right detection and ground contact time.

4. The system of claim 1, wherein values of biomechanical signal in the set of biomechanical signals map to a window of step segments.

5. The system of claim 1, wherein the processor enters a dynamic monitoring mode when the biomechanical signals satisfy a consistency condition or a performance condition; wherein, when in the dynamic monitoring mode, the processor is configured to enter a rest mode for a period of time, collect biomechanical signals for a second period of time, and determine if dynamic monitoring mode should continue.

6. The system of claim 1, wherein the processor is configured to operate in a wait state mode and in response to an activation signal, transition to a tracking mode.

7. The system of claim 1, wherein the activation signal is a detected activity state.

8. The system of claim 1, wherein the activity monitor system comprises a calibration mode that is configured to calibrate a pitch and a roll orientation.

9. The system of claim 8, wherein the housing of the activity monitoring device biases a forward-backwards orientation to one of two possibilities when the activity monitoring device is affixed to a user.

10. The system of claim 1, further comprising a remote data platform configured to host biomechanical signal data communicated from the user application, and further configured to manage biomechanical signal data communicated from multiple devices of additional users.

11. The system of claim 1, the activity monitor device further comprising an electrical interface that comprises at least two contact pads exposed on the external form of the housing.

12. The system of claim 11, wherein the electrical interface is an is an input of the activity monitor device, and the activity monitor device is configured to alter at least one process in response to an input signal detected through the electrical interface.

13. The system of claim 11, wherein the external form includes a first surface and a second surface; wherein the second surface is on a side opposite that of the first surface; wherein a first contact pad of the contact pads is exposed on the first surface and a second contact pad of the contact pads is exposed on the second surface; and wherein the external form is configured to promote orienting the activity monitor device with the first surface or the second surface in a forward dominant orientation when electrically coupling the electrical interface to an external device.

14. A method for tracking running activity comprising:
operating an activity monitor system in a wait state;
receiving an activation signal and transitioning the activity monitor system to a tracking mode;
in the tracking mode of the activity monitor system, collecting kinematic data from an inertial measurement unit of the activity monitor system and generating a set of biomechanical signals;
wirelessly communicating at least a portion of the biomechanical signals to a user application on a second computing device; and
generating a report.

15. The method of claim 14, comprising detecting communication signal strength and augmenting transmission strength of the activity monitor device.

16. The method of claim 14, wherein generating the set of biomechanical signals comprises dynamically generating the set of biomechanical signals at intermediate intervals.

17. The method of claim 14, further comprising: entering a dynamic monitoring mode when the biomechanical signals satisfy a consistency condition or a performance condition; when in the dynamic monitoring mode, entering a rest mode for a period of time, generating updated biomechanical signals for a second period of time, and evaluating the consistency condition and performance condition based on the updated biomechanical signals and determining if the dynamic monitoring mode should continue.

18. The method of claim 14, wherein the set of biomechanical signals comprises at least the biomechanical signals of cadence, pelvic tilt, vertical oscillation, braking, pelvic drop, pelvic rotation, and ground contact time.

19. The method of claim 18, wherein the set of biomechanical signals comprise the biomechanical signals of left-right detection and ground contact time.
